(19) United States
(12) Patent Application Publication
(10) Pub. No.: US 2026/0135122 A1
(43) Pub. Date: May 14, 2026

(54) CARBON ELECTRODES WITH SPATIAL GRADIENTS IN POROSITY FOR HIGH-POWER REDOX FLOW BATTERIES

(71) Applicants: Massachusetts Institute of Technology, Cambridge, MA (US); Eindhoven University of Technology, Eindhoven (NL)

(72) Inventors: Fikile Brushett, Cambridge, MA (US); Charles Tai-chieh Wan, Cambridge, MA (US); Antoni Forner-Cuenca, Eindhoven (NL); Remy Jacquemond, Eindhoven (NL)

(21) Appl. No.: 19/120,096

(22) PCT Filed: Oct. 12, 2023
(86) PCT No.: PCT/US2023/035030

§ 371 Date: Apr. 10, 2025

Related U.S. Application Data
(60) Provisional application No. 63/379,438, filed on Oct. 13, 2022.

(51) Int. Cl. H01M 4/96; H01M 4/86; H01M 4/88; H01M 8/18

(52) U.S. Cl. CPC H01M 4/96; H01M 4/861; H01M 4/8875; H01M 4/8882; H01M 8/188

(57) ABSTRACT

Disclosed are methods for fabricating a porosity gradient electrode. Also disclosed are porous electrodes. In this process, a single-phase mixture of scaffold-forming polymers dissolved in a solvent is driven into two-phases by a non-solvent, yielding a scaffold which can subsequently be thermally annealed into a carbonaceous and electrochemically active material.

### RELATED APPLICATIONS

This application claims the benefit of priority to U.S. Provisional Patent Application No. 63/379,438, filed Oct. 13, 2022, the contents of which are hereby incorporated by reference in their entirety.

### GOVERNMENT SUPPORT

This invention was made with government support under DMR-1419807 awarded by the National Science Foundation, and DE-AC02-06CH11357 awarded by the U.S. Department of Energy. The government has certain rights in the invention.

### BACKGROUND

Curtailing greenhouse gas emissions driving climate change while meeting societal energy demands is among the grandest challenges confronting humanity. Despite the unprecedented low costs of harvesting energy from renewables such as solar and wind, their inherent intermittency and unpredictability across multiple time scales from seconds to seasons stymies widespread penetration of renewables into the electric grid, motivating the development of energy storage technologies. Electrochemical systems have garnered interest for cost-effectively storing and releasing energy; while numerous battery technologies may be leveraged for this purpose, redox flow batteries (RFBs) have emerged as promising candidates for longer duration energy storage applications due to their decoupling of energy and power scaling by separating the electrolyte from the electrochemical stack in tandem with modular reactor components, safety, and long operational lifetimes. In RFBs, charge species are dissolved in electrolyte, stored in external tanks, and pumped through the porous electrodes within an electrochemical reactor. The oxidation and reduction of the charged species on the internal surfaces of the porous electrode interconvert chemical energy and electrical energy to store and discharge the battery. Despite their promise, adoption of RFB technologies has been limited, in large part due to their high costs which challenge the stringent economics of grid energy storage. Thus, research efforts have focused on developing new electrolyte formulations containing lower-cost or higher-performance redox couples, more efficient cells and stacks, and advanced reactor designs.

An effective strategy to reduce cost is to improve areal reactor power density. Tailoring the properties of core stack components (i.e., electrodes, membranes, flow fields) can reduce kinetic, ohmic, and transport resistances, thus augmenting overall reactor output. To this end, porous carbon electrodes play a central role in supporting multiple critical functions in the cell (and stack). Electrolyte travels through the flow field and is advected into the porous electrode, within which electrochemical reactions occur at the electrode-electrolyte interfaces. Therefore, the arrangement, connectivity, and volume of pores (i.e., microstructure) affects the electrolyte distribution throughout the electrode, and the electrode surface dictates local reactions rates. Commercial porous electrodes employed in RFBs are typically comprised of polyacrylonitrile- or Rayon-derived micrometric fibers arranged into a freestanding structure. While suitable for use in RFBs, as-received electrodes exhibit poor catalytic rates in state-of-the-art aqueous redox couples, necessitating post-process surface modifications, via thermal, electrochemical, or alternative routes, to impart catalytic functional groups and to increase electrochemically accessible surface area. Furthermore, as many leading porous electrodes used in RFBs were originally designed as gas diffusion layers (GDLs) for polymer electrolyte membrane (PEM) fuel cells (PEMFCs), their microstructure may not be optimal for the liquid-phase reactions they underpin.^{22,31} Thus, optimizing the surface chemistry, interfacial defects, and microstructure of the electrode offer opportunities for dramatic improvements in fluid dynamic and electrochemical performance.

A growing body of work has illuminated the importance of mass transport in energy efficient operation of high-power density redox flow cells. The microstructural diversity and post-process tunability of commercial electrodes is limited by available offerings. Approaches to develop bottom-up fabricated scaffolds enabling control over the design of pore shapes and morphologies to broaden the available pore network space and elucidate microstructure-function-performance relationships have gained traction. Most of these efforts have in large part focused on the research and engineering of fibrous electrospun materials. Sun and Jiang et al. showed that uniaxially-aligned fibers formed by electrospinning could enhance through- and in-plane permeability, increasing cell energy efficiencies as compared to operation with conventional electrospun materials, which have fibers that tend to be more randomly oriented. In additional studies, Sun et al. showed that hierarchical and ordered carbon fiber electrodes realized by growing carbon nanofibers on top of aligned electrospun carbon fibers could enable a favorable balance of kinetic and transport properties that facilitated high power density RFB cells. In a distinct but related approach, intertwined aligned microfibers have been shown to enable transformative performance improvements. These experimental advances have occurred in tandem with efforts to quantify the anisotropy of the three-dimensional (3D) electrospun structures, develop mass transfer correlations of anisotropic materials using multiphysics simulations, and screen microstructures and electrode properties via pore-scale computational approaches (i.e., pore network modeling, lattice boltzman, multiphysics with algorithmic optimization). Collectively, these results suggest that hierarchical porous structures with locally anisotropic channels can address mass transport limitations while providing ample surface area to alleviate kinetic overpotential.

A tangential strategy is to vary porosity profile in the direction perpendicular to the plane of the electrode (i.e., spatially varying porosity from the flow field to the separator) to direct electrolyte (or place additional surface area) into reaction-limited zones. This strategy is a departure from conventional RFB electrodes characterized by macrohomogeneous porosity. Indeed, electrochemical technologies with gaseous reactants or products (e.g., PEMFCs) contain multiple transport layers (e.g., gas diffusion layer, microporous layer, catalytic layer), each with distinct microstructure, surface chemistry, and wettability to support the efficient operation of the device. Porosity gradients have also been explored in assorted electrochemical systems to tune electrode surface area and transport to minimize resistive losses or undesirable processes. In lithium-ion (Li-ion) batteries, theoretical optimized porosity gradients in porous electrode models have been shown to reduce ohmic resistances and suppress parasitic side reactions by controlling spikes in local overpotentials to yield more uniform concentration profiles. In PEMFCs, porosity-graded electrospun GDLs have been leveraged to augment current density relative to a uniform, porosity GDL through, amongst other factors, improved water management. In PEM electrolyzers, positioning the lower porosity region of a graded transport layer adjacent to the catalyst layer was shown to lower mass transport overpotentials by 38%.

Accordingly, porosity gradient electrodes have been investigated in RFBs to balance mass transport and surface area throughout the electrode. The desire for a porosity gradient arises from the tension between providing surface area in reaction-limited zones while also supplying electrolyte uniformly throughout the electrode matrix, which require diametrically opposing porosities. Specifically, in a porous electrode, current distribution forms as a function of location within the electrochemical cell stemming from ionic current limited near the membrane-electrode interface. The conundrum is further complicated in RFBs as a result of the addition of convection, affecting mass transport from the bulk electrolyte to the electrode surface. Thus, supplying electrolyte to this limiting region by lowering the porosity is one strategy; increasing the electrode surface area near the membrane is another. Ultimately, tuning the porosity gradient is posited to enable more uniform electrolyte distribution while also providing sufficient surface area in the necessary regions. However, numerous viable negolyte and posolyte pairings in RFBs lead to systems with distinctive redox reaction rates and electrolyte properties (i.e., viscosity, density, and conductivity), and thus, current distributions and mass transport characteristics. Thus, determining the optimal directionality, shape, magnitude, average porosity, and local porosity of the gradient for each unique redox couple and electrolyte is still an active area of research.

We provide a brief summary of recent findings and prevailing hypotheses in the RFB literature. In an early demonstration, Wu et al. revealed that a dual-layered electrode composed of a high surface area electrospun catalyst layer near the membrane to facilitate reaction sites abutted against a commercial carbon paper electrode near the flow field to more effectively distribute electrolyte improved energy efficiency in a VRFB full-cell as compared to the performance with each individual component. Yoon et al. tuned the compression ratio, thickness, and stacking of carbon felts to experimentally and numerically examine the effect of varying porosity at the flow channel inlet, finding that lower porosity at the electrolyte inlet could improve VRFB cell performance at higher flow rates and current densities as compared to uniform porosity and/or lower porosity at the electrolyte outlet. Jiang et al. designed a porosity gradient electrode for VRFB cells by punching different amounts of holes in commercial SGL 39AA carbon papers to vary porosity and layering electrode of decreasing porosity from the flow field to the membrane; the perforated electrode assembly outperformed the baseline non-perforated materials. Chen et al. developed a simplified 2D multiphysics model to evaluate ten different electrode porosity profiles from an interdigitated flow field to the membrane, including linearly increasing, linearly decreasing, stepwise increasing, stepwise decreasing, constant minimum, and constant maximum porosity electrodes with an electrolyte flow rate of 10 mL min-1 and galvanostatic current density of 60 mA cm⁻². The authors found that increasing porosity from the flow field to the membrane led to more uniform electrolyte distribution, lower concentration overpotentials, and, in turn, improved discharge capacity and energy efficiency as compared to the electrodes of constant porosity at the bounds or decreasing porosity, at the expense of increased pumping losses. Stepwise increasing porosity with lower porosity at the outer quarter of the electrode abutting the flow field for an electrode thickness of 2.5 mm led to the best overall system efficiency (accounting for energy efficiency and pumping costs) of the set, though it is important to note that the system efficiency, energy efficiency, and discharge capacity are functions of the degree of porosity variation, electrode thickness, and location of the stepwise change in porosity. Subsequently. Chen and Kang sought to optimize porosity profiles in VRFB flow cells, extending their investigation to consider the case of fixed inlet flow for all porosity profiles, as well as the case of fixed pressure difference across the inlet and outlet for all porosity profiles. They found that the optimal porosity profile depended upon whether the inlet flow rate or pressure drop across their modeling domain was kept constant: in the first case of constant inlet flow rate, increasing porosity towards the membrane led to the most uniform electrolyte distribution and thus the best performance; in the second case of constant pressure drop, the constant maximum porosity and decreasing porosity towards the membrane produced the highest energy efficiency at the constant pressure leading to a more uniform electrolyte distribution throughout the electrode matrix. In yet another modeling study, Wang and Chen further explored the impact of vertically and diagonally varying porosity in VRFB full cells, finding that the best combination of electrode porosity gradients depended on certain parameters (e.g., porosity variation amplitude, electrode thickness, flow rate) and the desired metric (i.e., energy, pumping, or system efficiency). Lastly, Loretz et al. found that decreasing electrode porosity outwardly from the membrane in at least one or both electrodes leads to preferential convective flow to the region abutting the membrane where productive reactions tend to be more prevalent, decreasing the incidence of parasitic reactions; further, decreased contact resistance is observed. While these pioneering works shed light on the field, an outstanding challenge is to develop a versatile method of synthesizing porosity gradient electrodes compatible with manufacturing capabilities that can be scaled to commercially relevant volumes. Furthermore, consensus has not yet been reached on the optimal direction or features of the porosity profile, which appears to be nuanced and dependent on a multitude of desired operating conditions (e.g., flow rate, current density) and rank-ordered performance metrics (e.g., energy, pumping, or overall system efficiency).

### SUMMARY OF THE INVENTION

Disclosed is a bottom-up strategy to synthesize electrodes with porosity gradients for use in RFBs. First, we describe a non-solvent induced phase separation (NIPS) technique that enables the reproducible synthesis of freestanding, macrovoid-free electrodes with well-defined through-plane porosity gradients. Next, using a suite of microscopic, spectroscopic, and analytical methods, we quantify the monotonically varying porosity gradient profile and compare the physical properties and surface chemistries of porosity gradient electrodes to macrovoid electrodes, also synthesized by the NIPS method using an equivalent polymer formulation, confirming that they share similar surface chemistry and physical properties, though porosity gradient electrodes have higher gas physisorption-determined surface area. We then evaluate the electrochemical and fluid dynamic performance of the porosity gradient electrodes, exploring the effect of changing the direction of the porosity gradient across the electrode and benchmarking results against the macrovoid-containing electrode. We find the porosity gradient electrodes have lower permeabilities than their counterpart, and that trend in electrochemical performance in iron chloride depends on the flow rate. Last, we examine the performance in a vanadium redox flow battery (VRFB) full-cell, finding not only that the porosity gradient electrode significantly outperforms the macrovoid electrode, independent of gradient direction, but also that it performs favorably in comparison to other advanced electrodes described in the contemporary VRFB literature. More generally, we anticipate that the synthetic methods and results described herein will motivate further exploration of microstructurally tailored electrodes in electrochemical systems.

In one aspect, the present disclosure provides a method of fabricating a porosity gradient electrode, the method comprising
preparing a single-phase mixture of a scaffold-forming polymer, a pore-forming additive, and a solvent;
casting the single-phased mixture into molds;
submerging the molds in the solvent to produce treated molds;
submerging the treated molds in a non-solvent to produce a membrane;
removing the membrane from the molds;
soaking the membrane in the non-solvent;
drying the non-solvent-soaked membrane; and
thermally stabilizing the dried membrane, thereby forming the porosity gradient electrode.

In another aspect, the present disclosure provides porous electrodes (e.g., porous electrodes formed by the methods disclosed herein).

### BRIEF DESCRIPTION OF THE DRAWINGS

FIG. 1 shows a schematic of the phase separation process to yield macrovoid-free electrodes with through-plane porosity gradients. The mixture of PAN, PVP, and DMF is casted into an aluminum mold, where it is first submerged in a DMF bath for ca. 5 s, then transferred immediately into a DI water bath and left to phase separate overnight. The pre-DMF immersion bath creates a buffer zone at the top of the mold where local DMF concentration is higher, thus suppressing rapid phase separation through the depth of the polymer solution. The result is a macrovoid-free electrode with spatially varying porosity from the denser layer (DL) formed at the bath/mold interface to the porous layer (PL) formed at the polymer/mold interface.

FIGS. 2A-2C show scanning electron microscopy (SEM) and image analysis of cross-sectioned electrode.

FIG. 2A shows a SEM of the electrode without post-processing.

FIG. 2B shows a binarized version of the SEM image using thresholding. The gray value is determined by taking the average of the black and white pixels as a function of the position in the y-plane.

FIG. 2C shows the average porosity, determined as a function of normalized distance across three cross-sections of distinct samples (N=3).

FIG. 2D shows a stitched SEM across a broad length of the electrode, showing no macrovoid formation at the sub-centimeter scale.

FIGS. 3A-3F show the characterization of physicochemical properties of porosity gradient and macrovoid-containing electrodes.

FIG. 3A shows XPS survey scans based on atomic percentage for the G16_Bottom, G16_Top, and DMF_16 electrode.

FIG. 3B shows XPS quantification based on atomic percentage for the G16_Bottom, G16_Top, and DMF_16 electrode. Regions of the survey scan corresponding to C, N, and O are shaded in grey and labeled. Detailed and deconvoluted spectrums of the high-resolution C, N, and O scans can be found in FIG. 12.

FIG. 3C shows deconvoluted Raman spectra to determine the D and G bands of the porosity gradient electrodes.

FIG. 3D shows deconvoluted Raman spectra to determine the D and G bands of the DMF_16 electrodes. The spectra were deconvoluted from a range of 900-1900 cm⁻¹ into the D4, D1 (D), D3, G, and D2 bands through mixed Gaussian and Lorentzian curves. A summary of the peak locations, widths, and relative intensities of the D and G bands are provided in Table 2.

FIG. 3E shows a comparison of the X-ray diffraction patterns for the DMF_16, G16_Bottom, and G16_Top. The (002) and (10l) crystallographic planes are shaded grey in the diffractograms.

FIG. 3F shows Ar-gas physisorption of G16 and DMF_16 electrodes, with surface areas determined from BET analysis shown in the FIG. All trials were performed once (N=1).

FIGS. 4A-4E show experimental configurations and orientation of the electrode porosity gradient in the reactor.

FIG. 4A shows the configuration to estimate the pressure drop, and therefore permeability, of the electrodes.

FIGS. 4B-4D show reactor configurations to examine electrochemical cell performance for iron chloride single-electrolyte polarization and impedance (FIG. 4B), iron chloride symmetric cell limiting current (FIG. 4C), and full cell vanadium RFB evaluation (FIG. 4D).

FIG. 4E shows the electrodes investigated in this study and how they are oriented with respect to the flow field and separator are shown in, where G16_PLM refers to the more porous layer facing the membrane, G16_DLM refers to the denser layer facing the membrane, and DMF_16 refers to the macrovoid-containing electrode.

FIGS. 5A & 5B show pressure drop measurements for two directions of the porosity gradient and macrovoid electrode.

FIG. 5A shows representative pressure drop through the electrode as a function of linear velocity.

FIG. 5B Permeability extracted using the Darcy-Forchheimer equation (inset). Interdigitated flow fields were used with DI water as the working fluid. All trials were performed in triplicate (N=3).

FIGS. 6A-6F show the electrochemical performance of electrodes in iron chloride in the single-electrolyte configuration. The electrolyte solution was 0.25 M Fe²⁺ and 0.25 M Fe³⁺ in 2 M HCl supporting electrolyte. A Daramic 175 membrane was used, along with IDFF at a ca. 20% compression. Polarization response of electrodes in iron chloride at 2 (FIG. 6A), 0.5 (FIG. 6B), and 0.1 (FIG. 6C) cm s⁻¹ linear velocity for the DMF_16, G16_PLM, and G16_DLM electrodes. Representative ohmically-corrected Nyquist plots from EIS and breakdown of resistances are shown at linear velocities of 2 (FIG. 6D), 0.5 (FIG. 6E), and 0.1 cm s⁻¹ (FIG. 6F); experimental data points (symbols) are fit to the modified Randles equivalent circuit model shown in the inset of (FIG. 6D). The bars show the breakdown in the contribution of ohmic, charger transfer, and mass transport resistances to overall cell resistance. All trials for each sample were performed in duplicate (N=2).

FIGS. 7A & 7B show limiting current measurements in iron chloride for phase separated electrodes.

FIG. 7A shows representative data extracted during limiting current measurement, during which the potential is increased until the current plateaus.

FIG. 7B shows mass transfer coefficient multiplied by the volumetric surface area as a function of superficial velocity. The proportionality constant of a·kₘ as a function of the superficial velocity is shown on the insets of the graph. The electrolyte solution was 0.05 M Fe²⁺ in 0.75 M Fe³⁺ in 2 M HCl supporting electrolyte to probe solely the oxidation of Fe²⁺. All trials for each sample were performed in triplicate (N=3).

FIGS. 8A-8G show the evaluation of electrodes in 1.0 M vanadium in 3.0 M H₂SO₄ electrolyte for the gradient porosity electrode and the macrovoid-containing electrode at a 2 cm s⁻¹ linear velocity. FIGS. 8A-8C show galvanostatic cycling curves at current densities of 100, 200, and 300 mA cm⁻². FIGS. 8D-8F Coulombic, voltaic, and energy efficiencies as a function of current densities from 100, 150, 200, 250, and 300 mA cm⁻², followed by recovery to 100 mA cm⁻². FIG. 8G show the efficiencies and discharge capacity of the G16_PLM over 200 cycles at a current density of 100 mA cm⁻². The theoretical maximum discharge capacity, determined to be 26.9 Ah L⁻¹ for 15 mL of electrolyte and 1.0 M vanadium, is plotted for reference. All trials were performed once (N=1).

FIG. 9 shows the discharge polarization and power density curves for electrodes at a 2 cm s⁻¹ linear velocity in 1.0 M vanadium in 3.0 M H₂SO₄. Current density was increased at intervals of 20 mA cm⁻² and held for ca. 20 s. All trials were performed once (N=1).

FIG. 10 shows cross-sectional SEM images of materials synthesized using the porosity gradient method using a higher solids content, in order of increasing PAN to PVP ratio from top to bottom. While porosity gradients are evident for all three electrodes, the porosity of the electrodes proved to be unsuitable for flow electrochemistry. The direction of increasing porosity is indicated underneath each electrode.

FIG. 11 shows log differential intrusion as a function of pore size diameter from MIP analysis for the porosity gradient electrode (G16) and the macrovoid electrode (DMF_16). G refers to gradient. DMF refers to the solvent, and 16 refers to the total polymer solids content as a percentage.

FIG. 12 shows deconvolution of high-resolution XPS data for G16_Bottom (top row), G16_Top (middle row), and DMF_16 (bottom row). The spectra for C1s (left column), Ols (middle column), and N1s (right column) are shown. G refers to gradient. DMF refers to the solvent, and 16 refers to the total polymer solids content as a percentage.

FIGS. 13A-13D show the electrochemically active surface area measurements estimated using double-layer capacitance of porosity gradient materials.

FIG. 13A shows representative cyclic voltammograms for G16_PLM at scan rates of 20, 50, 100, 200, 300, and 400 mV s⁻¹.

FIG. 13B shows averaged magnitudes of oxidative and reductive currents for G16_PLM at 0) V as a function of scan rate ranging from 5-400 mV s⁻¹.

FIG. 13C shows representative cyclic voltammograms for G16_DLM at scan rates of 20, 50, 100, 200, 300, and 400 mV s⁻¹.

FIG. 13D shows veraged magnitudes of oxidative and reductive currents for G16_DLM at 0 V as a function of scan rate ranging from 5-400 mV s⁻¹. The dotted gray lines in FIGS. 13B & 13D are linear fits to the points. Error bars are one standard deviation around the means for two independent experiments for each electrode configuration (N=2).

FIG. 14 shows a comparison of the specific surface area for the DMF_16, G16_PLM, and G16_DLM through electrochemically accessible surface area estimated via double-layer capacitance and Ar-BET gas physisorption. The Ar-BET surface area is the same for both G16_PLM and G16_DLM. The electrochemically accessible surface area for the DMF_16 was harvested from our previous work. Error bars are standard deviations of two independent trials for each electrode (N=2).

FIG. 15 shows the permeability and ECSA of the porosity gradient materials alongside NIPS electrodes¹¹ and commercial carbon fiber-based materials. NIPS electrodes, shown in dark gray, are labeled according to the following convention: Solvent-Polymer concentration (g/mL)-Temperature coagulation bath (° C.). Commercial fibrous electrodes are shown in light gray. Error bars for ECSA and permeability are standard deviations for two samples (N=2).

FIG. 16 shows grouped and stacked column chart of the breakdown of resistances from mass transfer (R_{MT}) and charge transfer (R_{CT}) from fitting Nyquist plots to a modified Randles equivalent circuit. Resistance breakdown is grouped by superficial velocity and subcategorized by electrode. Error bars are one standard deviation from EIS fits for each electrode performed in duplicate (N=2).

FIG. 17 shows vanadium RFB performance comparison of porosity gradient electrode, G16_PLM, to various designer electrodes from data harvested in the literature. Energy efficiencies from galvanostatic charge-discharge curves are plotted as a function of current density.

### DETAILED DESCRIPTION OF THE INVENTION

In one aspect disclosed herein is a methodology to synthesize porosity gradient electrodes for use in RFBs and evaluate their performance. We recently developed a new class of electrode microstructures through a facile, versatile, and potentially scalable process known as non-solvent induced phase separation (NIPS). In this process, a single-phase mixture of scaffold-forming polymers dissolved in a solvent is driven into two-phases by a non-solvent, yielding a scaffold which can subsequently be thermally annealed into a carbonaceous and electrochemically active material. These microstructures, under the parameters sets in our previous work, show clear polydisperse pore distributions containing large pores (termed “macrovoids”) leading into small pores (termed “microvoids”) that balance electrochemical and fluid dynamic processes within the electrodes. Additionally, these architectures hold promise to enable high power density VRFBs. The disclosure herein extends offerings attainable from the NIPS method to create materials with monotonically varying porosity profiles by introducing a pre-immersion step in the solvent (here, DMF) prior to exposure to the non-solvent, buffering the phase separation process, delaying demixing and, thus, preventing macrovoid formation. We systematically characterize the surface chemistry and physical properties of the porosity gradient and juxtapose them to a macrovoid-containing structure synthesized with the same polymer and solvent formulations, finding minimal differences in physicochemical characteristics. Subsequently, we employ single-electrolyte flow cell measurements with the porosity gradient electrode to compare the effect of changing the direction of the porosity gradient from the flow field to the membrane on the fluid dynamic and electrochemical performance, and further benchmark those results to the macrovoid-containing structure. These efforts culminate in galvanostatic cycling and discharge polarization of a VRFB full cell. Ultimately, our aim is to illustrate opportunities for the development of high-performance porosity gradient electrodes for RFBs.

In one aspect, the present disclosure provides a method of fabricating a porosity gradient electrode, the method comprising
preparing a single-phase mixture of a scaffold-forming polymer, a pore-forming additive, and a solvent;
casting the single-phased mixture into molds;
submerging the molds in the solvent to produce treated molds;
submerging the treated molds in a non-solvent to produce a membrane;
removing the membrane from the molds;
soaking the membrane in the non-solvent;
drying the non-solvent-soaked membrane; and
thermally stabilizing the dried membrane, thereby forming the porosity gradient electrode.

In certain embodiments, the scaffold-forming polymer is selected from the group consisting of polyacrylonitrile (PAN), a PAN derivative, pitch, rayon, phenolic resins, polyimides, PIMS, polyfurfuryl alcohol (PFA), polyetherimide (PET), poly(2,6-dimethyl-1,4-phenylene oxide) (PPO), and poly(phthalazinone ether sulfone ketone) (PPESK). In certain preferred embodiments, the scaffold-forming polymer is polyacrylonitrile (PAN).

In certain embodiments, the pore-forming additive is selected from the group consisting of polyvinylpyrrolidone (PVP), polyacrylic acid (PAA), polyacrylamide (PAM), N(2-Hydroxypropyl) methacrylamide (HPMA), poly [N-(2-hydroxy) methacrylamide] (HPMA), and polyethyleneglycol (PEG). In certain preferred embodiments, the pore-forming additive is polyvinylpyrrolidone (PVP).

In certain embodiments, the solvent is a polar aprotic organic solvent. In certain embodiments, the polar organic solvent is N,N-dimethylformamide (DMF).

In certain embodiments, submerging the molds in the solvent is completed in less than about 1 second(s), 2 s. 5 s, 10 s. 20 s, or 40 s. In certain embodiments, submerging the molds in the solvent is completed in less than about 1 second. In certain embodiments, submerging the molds in the solvent is completed in less than about 2 seconds. In certain embodiments, submerging the molds in the solvent is completed in less than about 5 seconds. In certain embodiments, submerging the molds in the solvent is completed in less than about 10 seconds. In certain embodiments, submerging the molds in the solvent is completed in less than about 20 seconds. In certain embodiments, submerging the molds in the solvent is completed in less than about 40 seconds.

In certain embodiments, the molds are submerged in the water for about 1 hours, about 2 hours, about 4 hours, about 8 hours, about 12 hours, about 16 hours, or about 24 hours. In certain embodiments, the molds are submerged in the water for about 1 hours. In certain embodiments, the molds are submerged in the water for about 2 hours. In certain embodiments, the molds are submerged in the water for about 4 hours. In certain embodiments, the molds are submerged in the water for about 8 hours. In certain embodiments, the molds are submerged in the water for about 12 hours. In certain embodiments, the molds are submerged in the water for about 16 hours. In certain embodiments, the molds are submerged in the water for about 24 hours.

In certain embodiments, submerging the treated molds in water comprises submerging the treated molds in boiling water. In certain embodiments, submerging the water is deionized water. In certain embodiments, submerging the treated molds in water is repeated until the water appears substantially clear. In certain embodiments, submerging the treated molds in water is repeated until the water appears completely clear.

In certain embodiments, drying the water-soaked membrane is performed under vacuum. In certain embodiments, drying the water-soaked membrane is performed at about 50° C., about 60° C., about 80° C., about 90° C. or about 100° C. In certain embodiments, drying the water-soaked membrane is performed at about 50° C. In certain embodiments, drying the water-soaked membrane is performed at about 60° C. In certain embodiments, drying the water-soaked membrane is performed at about 70° C. In certain embodiments, drying the water-soaked membrane is performed at about 80° C. In certain embodiments, drying the water-soaked membrane is performed at about 90° C. In certain embodiments, drying the water-soaked membrane is performed at about 100° C.

In certain embodiments, drying the water-soaked membrane is performed for at least about 1 hour. In certain embodiments, drying the water-soaked membrane is performed for about 1 hour, about 2 hours, about 3 hours, about 4 hours, about 6 hours, or about 10 hours. In certain embodiments, drying the water-soaked membrane is performed for about 1 hour. In certain embodiments, drying the water-soaked membrane is performed for about 2 hours. In certain embodiments, drying the water-soaked membrane is performed for about 3 hours. In certain embodiments, drying the water-soaked membrane is performed for about 4 hours. In certain embodiments, drying the water-soaked membrane is performed for about 6 hours. In certain embodiments, drying the water-soaked membrane is performed for about 10 hours.

In certain embodiments, thermally stabilizing the dried membrane is performed in a muffle furnace. In certain embodiments, thermally stabilizing the dried membrane is performed at about 225° C. about 250° C., about 270° C., about 300° C., about 350° C., or about 400° C. In certain embodiments, thermally stabilizing the dried membrane is performed at about 225° C. In certain embodiments, thermally stabilizing the dried membrane is performed at about 250° C. In certain embodiments, thermally stabilizing the dried membrane is performed at about 270° C. In certain embodiments, thermally stabilizing the dried membrane is performed at about 300° C. In certain embodiments, thermally stabilizing the dried membrane is performed at about 350° C. In certain embodiments, thermally stabilizing the dried membrane is performed at about 400° C.

In certain embodiments, thermally stabilizing the dried membrane by heating is performed for about 0.5 hours, about 1 hours, about 2 hours, about 5 hours, or about 7 hours. In certain embodiments, thermally stabilizing the dried membrane is by heating is performed for about 0.5 hours. In certain embodiments, thermally stabilizing the dried membrane is by heating is performed for about 1 hour. In certain embodiments, thermally stabilizing the dried membrane is by heating is performed for about 2 hours. In certain embodiments, thermally stabilizing the dried membrane is by heating is performed for about 5 hours. In certain embodiments, thermally stabilizing the dried membrane is by heating is performed for about 7 hours.

In certain embodiments, following the thermal stabilization of the dried membrane, the membrane is cooled to ambient temperature. In certain embodiments, following the thermal stabilization of the dried membrane, the membrane is cooled to ambient temperature without active cooling.

In certain embodiments, the thermally stabilized membrane is placed between two graphite blocks milled down to a thickness of about 0.1 cm, about 0.2 cm, about 0.25 cm, about. 0.3 cm, about 0.318 cm, about 0.325 cm, about 0.4 cm, or about 0.5 cm.

In certain embodiments, the method further comprises carbonizing the thermally stabilized membrane. In certain embodiments, carbonizing the thermally stabilized membrane comprising heating the thermally stabilized membrane under an internet atmosphere (e.g., under an atmosphere of nitrogen). In certain embodiments, heating the thermally stabilized membrane under an internet atmosphere comprises heating the thermally stabilized to about 1,050° C. In certain embodiments, the thermally stabilized membrane is heated at a rate of about 5° C. per minute to about 850° C., held at 850° C. for about 40 minutes, and then heated to 1,050 at a rate of about 5° C. per minute to 1,050° C.

In certain embodiments, the method further comprises submerging the molds in water prior to prior to submerging the molds in the solvent.

In another aspect, the present disclosure provides methods of fabricating a porosity gradient electrode, the method comprising
a. preparing a single-phase mixture of polyacrylonitrile, polyvinylpyrrolidone, and N,N-dimethylformamide;
b. casting the single-phased mixture of PAN, PVP, and DMF into molds;
c. submerging the molds in DMF to produce treated molds;
d. submerging the treated molds in water to produce a membrane;
e. removing the membrane from the molds;
f. soaking the membrane in water;
g. drying the water-soaked membrane;
h. thermally stabilizing the dried membrane.

In certain embodiments, the submerging the molds in DMF is completed in less than 1 second(s), 2 s, 5 s, 10 s, 20 s, or 40 s.

In certain embodiments, the submerging the molds in water is for 1 h, 2, h, 4 h, 8 h, 12 h, 16 h, or 24 h.

In certain embodiments, the submerging the treated molds in water comprises submerging the treated molds in boiling DI water. In certain embodiments, the submerging the treated molds in water is repeated until the water appear completely clear.

In certain embodiments, the drying the water-soaked membrane is under vacuum.

In certain embodiments, the drying the water-soaked membrane is at 50° C., 60° C., 80° C., or 100° C.

In certain embodiments, the drying the water-soaked membrane is for ≥1 h, 2 h, 3 h, 4 b, 6 h, or 10 h.

In certain embodiments, the thermally stabilizing the dried membrane is in a muffle furnace.

In certain embodiments, the thermally stabilizing the dried membrane is at 225° C., 250° C., 270° C., 300° C., 350° C., or 400° C.

In certain embodiments, the thermally stabilizing the dried membrane is by heating for 0.5 h, 1 h, 2 h, 5 h, or 7 h, followed by a cool down to room temperature without intervention. In certain embodiments, the heating has a ramp rate of 0.5° C., 1° C., 2° C., or 2.5° C.

In certain embodiments, the thermally stabilized membrane is placed between two graphite blocks milled down to a thickness of 0.1 cm, 0.2 cm, 0.25 cm, 0.3 cm, 0.318 cm, 0.325 cm, 0.4 cm, or 0.5 cm.

In certain embodiments, the method further comprises carbonizing the milled, thermally stabilized membranes in a tube furnace under flowing nitrogen at a ca. 2 L min⁻¹ flow rate. In certain embodiments, the carbonizing comprises heating at a rate of 5° C. min⁻¹, holding for 40 min, cooling down to room temperature without intervention.

In certain embodiments, the method further comprises submerging the molds in water prior to submerging the molds in DMF in c.

In another aspect, the present disclosure provides porous electrodes formed by the methods disclosed herein.

In another aspect, the present disclosure provides porous electrodes comprising PAN and PVP.

In another aspect, the present disclosure provides porous electrodes comprising PAN and PVP having an I_{D} (cm⁻¹) of about 1,345, an I_{D} width (cm⁻¹) of about 189, an I_{G} (cm⁻¹) of about 1,585, an I_{G} width (cm⁻¹) of about 87, and an I_{D}/I_{G} ratio of about 1.55, as determined by Raman spectroscopy.

In another aspect, the present disclosure provide porous electrodes comprising PAN and PVP having an I_{D} (cm⁻¹) of 1.345, an I_{D} width (cm⁻¹) of 189, an I_{G} (cm⁻¹) of 1.585, an I_{G} width (cm⁻¹) of 87, and an I_{D}/I_{G} ratio of 1.55, as determined by Raman spectroscopy.

In certain embodiments, the pores are about 1-5 μm in diameter. In certain embodiments, the pores are about 1 μm in diameter. In certain embodiments, the pores are about 2 μm in diameter. In certain embodiments, the pores are about 3 μm in diameter. In certain embodiments, the pores are about 4 μm in diameter. In certain embodiments, the pores are about 5 μm in diameter.

In certain embodiments, the porous electrode is substantially free of macrovoids. In certain embodiments, the porous electrode is free of macrovoids. In certain embodiments, the porous electrode is does not comprise macrovoids.

In another aspect, the present disclosure provides a battery comprising the porous electrodes disclosed herein.

In another aspect, the present disclosure provides a redox flow battery comprising the porous electrodes disclosed herein.

In another aspect, the present disclosure provides a fuel cell comprising the porous electrodes disclosed herein.

In another aspect, the present disclosure provides an electrolyzer comprising the porous electrodes disclosed herein.

### Definitions

Unless otherwise defined herein, scientific and technical terms used in this application shall have the meanings that are commonly understood by those of ordinary skill in the art. Generally, nomenclature used in connection with, and techniques of chemistry described herein, are those well-known and commonly used in the art.

The methods and techniques of the present disclosure are generally performed, unless otherwise indicated, according to conventional methods well known in the art and as described in various general and more specific references that are cited and discussed throughout this specification.

Chemistry terms used herein, unless otherwise defined herein, are used according to conventional usage in the art, as exemplified by “The McGraw Hill Dictionary of Chemical Terms”, Parker S., Ed., McGraw-Hill, San Francisco, C.A. (1985).

### EXAMPLES

The invention now being generally described, it will be more readily understood by reference to the following examples, which are included merely for purposes of illustration of certain aspects and embodiments of the present invention, and they are not intended to limit the invention.

### Example 1: Preparation and Characterization of Exemplary Electrodes

### Membrane Formation and Phase Separation

Polyacrylonitrile (PAN, average MW˜150,000, Sigma Aldrich), polyvinylpyrrolidone (PVP, average MW˜1,300,000, Alfa Aesar), and N,N-Dimethylformamide (DMF, suitable for HPLC, ≥99%. Sigma Aldrich) were dissolved through continuous mixing with a metal spatula and heating at 70° C. in a drying oven (Heratherm OMH60, ThermoScientific) in a 100 mL Pyrex® Media Bottle (VWR) for a total of ca. 1 h. Afterwards, the media bottle was placed on a roller mixer (SCI-T6-S, Scilogex) at a setting of ca. 40 rpm at room temperature. The viscous mixture was subsequently casted into five separate aluminum molds (7 cm×5 cm×0.11 cm) arranged on a 12″×8″×⅛″ (L×W×H) glass substrate (McMaster-Carr). A glass microscope slide (McMaster-Carr. 1149T11) was used to evenly distribute the solution into the aluminum molds. To create scaffolds with macrovoid structures, the casted molds were rested in ambient conditions for ca. 15 min to enable vapor induced phase separation (VIPS) which results in removal of the dense top layer; then, the entire assembly was submerged into a 1.25 gallon capacity 17¼″×10¾″×2⅜″ (L×W×H) glass pan (McMaster-Carr) filled with 3 L of deionized (DI) water (Milli-Q Millipore, 18.2 MΩ cm) to initiate the non-solvent induced phase separation (NIPS) process, where the PVP and DMF leach into the DI water bath, resulting in a porous PAN microstructure. For the macrovoid-free porosity gradient structures, the VIPS step was omitted, and instead, after casting, the entire assembly was submerged into a separate glass pan filled with of 1 L DMF for ca. 5 sec, and then immediately transferred into the 3 L DI water bath to complete the phase separation process. Exposing the casted molds to DMF created a buffer between the non-solvent and the solution, reducing instantaneous demixing, and preventing the formation of macrovoids (vide infra for a more detailed discussion of the hypothesized mechanism). This resulted in a porosity profile that naturally increases when going from the bath/solution interface to the solution/glass substrate interface. The membranes were left in the water bath overnight to allow for the phase separation process to equilibrate.

### Drying, Thermal Stabilization, and Carbonization of Membranes

After the phase separation process, the membranes were removed from the molds and soaked in a 1200 mL crystallizing dish (VMR) with boiling DI water to drive additional PVP and DMF removal in a vented fume hood. The boiling water was replaced periodically until the water appeared completely clear (ca. 3 to 4 rinses over a 1 h span). Then, the membranes were dried between Scott® C-Fold paper towels (VWR), placed between two 1/16″ thick PTFE sheets (McMaster-Carr) cut to 10″×8″ (L×W), sandwiched between 10″×8″×⅛″ glass plates (McMaster-Carr) with a total applied weight of ca. 372 g, and dried under vacuum (ca. 2 Torr) using a Welch 2032 vacuum pump (Cole-Parmer) in a vacuum oven (Fisher Scientific) at 80° C. for ≥4 h. The dried membranes were then removed from between the PTFE sheets and placed between two sheets of alumina paper (ZIRCAR Ceramics Inc.), compressed by a graphite block (Isomolded Graphite Plate, Fuel Cell Store) machined into a 12 cm×14 cm×0.318 cm (L×W×H) prism weighing ca. 50 g. and thermally stabilized in a muffle furnace (Barnstead Thermolyne Type 47900) at 270° C. for 1 h with a ramp rate of 2° C. followed by a cool down to room temperature without intervention. The thermally-stabilized membranes were then placed in between two graphite blocks (McMaster-Carr, 9121K67) m down to a thickness of 0.318 cm with a total applied weight of 124 g on the thermally-stabilized membranes, and carbonized in a tube furnace (GHA 12/300 Furnace, Carbolite) under flowing nitrogen (Airgas, 99.999%) at a ca. 2 L min⁻¹ flow rate using the following sequence: ramp from room temperature to 850° C. at a rate of 5° C. min⁻¹, hold for 40 min, ramp to 1050° C. at a rate of 5° C. min⁻¹, hold for 40 min, cool down to room temperature without intervention. The synthesized electrodes were stored in plastic containers under ambient conditions.

### Ex Situ Characterization

### Scanning Electron Microscopy (SEM)

Micrographs were collected on a Phenom ProX desktop SEM (Nanoscience Instruments Inc.). A 15 kV electron energy, ca. 6.5 mm working distance, and ca. 370× magnification were used to collect the images. Cross-sections of the electrodes were obtained by cutting samples using a razor blade and mounting onto the stage using conductive carbon tape (Ted Pella Inc.). Three porosity gradient electrode cross-sections from different samples were imaged.

### X-Ray Photoelectron Spectroscopy (XPS)

Following the conditions of a previous report, the electrode surface chemistry was analyzed using a Thermo Scientific K-Alpha equipped with a monochromatic small-spot X-ray source and a 180° double focusing hemispherical analyzer with a 128-channel detector (N=1 for each electrode type). Spectra were recorded with an aluminum anode (Al Kα=1486.6 eV) operating at 72 W with a spot size of 400 μm in diameter. Survey scans were measured at a constant pass energy of 200 eV and region scans at 50 eV. The background pressure was 2×10⁻⁹ mbar, and the pressure used during measurements was 3×10⁻⁷ mbar (argon) because of the charge compensation dual beam source. Spectra were characterized using the Avantage software program.

### Raman Spectroscopy

Following the conditions of a previous report, the molecular vibrational modes of the electrodes were examined using a 300R confocal Raman microscope (N=1 for each electrode type). The laser used for Raman was a UHTS300S_Green_NIR at a wavelength of λ=532.306 nm. The grating (G2) had a groove density of 600 gr mm⁻¹ and a blaze wavelength (BLZ) of 500 nm. The spectral center was set at 2400 cm⁻¹, and the integration time was set at 5 s. Every sample was analyzed using the laser power set at 4.822 mW with a total of 50 accumulations. Deconvolution of spectra was conducted using Raman Environment (WiRE) software.

### X-Ray Diffraction (XRD)

Spectra of as-synthesized porosity gradient and macrovoid electrodes (N=1 for each electrode type) were collected using a PANalytical X'Pert Pro MPD (Malvern Panalytical, UK) in the Open Eularian Cradle configuration. A Cu tube power of 45 kV and 40 mA was used. A fixed aperture of ¼° with a ½° soller slit was used during collection. The X-ray source was a Cu anode with a K-Alpha wavelength of 1.54060 Å. The scan was from 10-90°, with a step size of 0.00836°, a scan speed of 0.054° s⁻¹, and 20 s per step, resulting in a ca. 25 min scan. Spectra and peak analysis were conducted using the HighScore Plus program.

### Ar-Gas Physisorption Measurements to Estimate Surface Area

The Brunauer-Emmett-Teller (BET) surface area of the electrode materials was measured with a TriStar II PLUS instrument. The different electrodes were cut into square of ˜2 mm×2 mm and dried at 80° C. under vacuum for 24 h prior to analysis. Between 95 and 115 mg of material was used for each BET surface area analysis. Helium was used to titrate the volume of voids in the measuring vessel (volume not occupied by the sample). After helium evacuation and purging the measuring vessel with argon, the partial pressure of argon was slowly ramped from p/p⁰=0 until 0.98 after which the reverse process was performed. The quantity of adsorbed gas was used to recalculate the surface are of the porous electrodes using the BET theory.

### Mercury Intrusion Porosimetry (MIP)

Following the conditions of a previous report, analysis of pore size distributions was performed using an AutoPore IV 9500 using ca. 50-100 mg electrode samples and a 5 cm³ volume penetrometer. Pore diameters were calculated assuming a cylindrical shape and mercury-carbon contact angles of 130° (advancing and receding). The porosity of the bulk electrodes was estimated by registering the mass of the material before and after full imbibition with mercury, assuming a complete pore filling. The electrode samples were first cut into small square pieces of approximately 1 mm×1 mm before loading in the penetrometer. This sample preparation was used to statistically reduce possible ink-bottle artifacts coming from the presence of macrovoids to get a better approximation of the “true” pore size distribution of measured samples.

### Image Analysis Procedure

SEM images were binarized and analyzed using Fiji version 2.3.0/1.53q. Images thresholding was performed by setting pixels from 140 to 255 as part of the solid matrix, and anything below 140 as the pore space. A density profile spanning the cross-section was extracted and fit to an exponential with an offset function in Fiji, yielding the profile for the solid matrix based on the positionally averaged gray values, GV(z). To obtain the porosity, ϵ, the solid matrix profile was inverted using the equation

$$ϵ ( z ) = 1 - \frac{GV ( z )}{255} .$$

The values for three cross-sections of distinct samples were averaged to determine the porosity profile.

### Flow Cell Measurement Setup

All flow cell measurements were performed in a flow cell with a 1.5 cm×1.7 cm (2.55 cm²) active electrode area. 1× electrode was used on each side (i.e., one positive electrode and one negative electrode without stacking). The thickness of PTFE gaskets (McMaster-Carr) were selected such that the electrode stack was compressed by ca. 20% for all experiments. Nominal electrode thicknesses were measured using a dial thickness gauge (500-195-30, Mitutoyo); the thicknesses for the porosity gradient and macrovoid electrodes were measured to be 468.3±21.7 μm and 575.5±11.2 μm, respectively. Interdigitated flow fields (IDFFs), milled from Tokai G347B resin-impregnated graphite plates of 3.18 mm thickness (Tokai Carbon Co.), were also employed, along with a Daramic® 175 (175 μm thick, Daramic) microporous separator for iron chloride experiments and a Nafion™ 212 membrane (N212, 50.8 μm nominal thickness, Fuel Cell Store) presoaked in 3.0 M HCl for ≥24 h. Flow rates were maintained with a MasterFlex™ pump (Cole-Parmer) and circulated using LS/14 Norprene™ tubing (Cole-Parmer).

### Permeability Measurements

Measurements were performed in the 2.55 cm² flow cell with an IDFF sandwiched with an impermeable resin-impregnated graphite backing plate (G347B, Tokai Carbon Co.) with DI water as the working fluid. The pressure drop was determined by taking the difference between the pressure at the inlet and outlet of the cell using digital gauges (XP2i Digital Pressure Gauge, AMETEK STC). The flow rate was increased from 5 to 90 mL min⁻¹, and then decreased back to 5 mL min⁻¹ at increments of 5 mL min⁻¹. Each flow rate was held for 20 sec to ensure a stable reading was obtained. All trials for each electrode type were performed in triplicate (N=3). The experimentally measured data was fit to the Darcy-Forchheimer equation in MATLAB® 2022a to extract permeability values.

### Iron Chloride Flow Cell Experiments

Iron (II) chloride tetrahydrate (FeCl₂·4H₂O, 98%, Sigma Aldrich), iron (III) chloride hexahydrate (FeCl₃·6H₂O, 97%. Sigma Aldrich), and hydrochloric acid (HCl, 37%, balance of water, Sigma Aldrich) were dissolved in DI water and used as received with no further purification prior to experiments. For the single electrolyte experiments, the concentration of active species was 0.25 M Fe²⁺ and 0.25 M Fe³⁺ for a total concentration of 0.5 M at 50% state-of-charge (SoC) in 2 M HCl electrolyte. For the limiting current experiments, the concentration of active species was 0.05 M Fe²⁺ and 0.75 M Fe³⁺ for a total concentration of 0.8 M in 2 M HCl electrolyte; the concentration of Fe²⁺ was intentionally lower to ensure that limiting currents were determined by the oxidation of Fe²⁺. For both limiting current and single-electrolyte experiments, the order of experiments was from high to low flow rates. An in-house built redox flow cell with a 2.55 cm² (1.5 cm×1.7 cm) geometric active area was used in all flow battery experiments, along with IDFFs with 4 inlet channels and 3 outlet channels; engineering drawings are provided in a previous open-access report. Daramic 175 (175 μm thick, Daramic) microporous separator was used. The volumetric flow rate was adjusted to match superficial electrode velocities. PTFE gaskets (McMaster-Carr) cut with 1.5 cm×1.7 cm openings were selected to have a thickness ca. 80% of the nominal electrode thickness, leading to a ca. 20% electrode compression. For the single-electrolyte polarization measurements, a constant voltage was applied beginning at 0 V and increasing stepwise by 25 mV and up to 0.4 V, with a 1 min hold at each potential. The current from the last 50% of each potential hold was averaged and reported to ensure the cell had reached steady state. For the EIS measurements, a 10-mV potential amplitude around open-circuit voltage (OCV) was used across a range of 200 Hz to 10 mHz with 6 points per decade in logarithmic spacing and 2 average measures per frequency. For the limiting current experiments, a constant voltage was applied beginning at 0 V and increasing stepwise by 25 mV until a limiting current was reached (usually up to 0.6 V). A 30 sec hold was employed at each potential, and the last half of the recorded current at each potential hold was averaged to ensure the cell was near steady state. 15 mL of 0.25 M Fe²⁺ and 0.25 M Fe³⁺ in 2 M HCl electrolyte was used for the polarization and EIS experiments, while 50 mL of 0.05 M Fe²⁺ and 0.75 M Fe³⁺ in 2 M HCl electrolyte was used for the limiting current experiments. Measurements for the single-electrolyte polarization and impedance were conducted using a Bio-Logic VSP potentiostat (Bio-Logic), whereas measurements for the limiting current experiments were conducted with an Arbin battery tester (FBTS-8).

### Evaluation in a Single Vanadium Redox Flow Battery

For all experiments, the starting solution consisted of 1 M vanadium (IV) sulfate oxide hydrate (99.9%, Fisher Scientific) and 3 M sulfuric acid (H₂SO₄, 95.0-98.0%, Sigma Aldrich) dissolved in DI water. A Nation 212 membrane (50.8 μm nominal thickness, Fuel Cell Store) was pretreated by soaking in 3 M H₂SO₄ for ≥24 h prior to use. IDFF flow fields were used and the electrodes were compressed by ca. 20%. Briefly, a potential of 1.7 V is applied to posolyte and negolyte both containing 1 M V(IV) in 3 M H₂SO₄ until a current of 10 mA is reached, at which point the posolyte is oxidized to V(V) and the negolyte is reduced to V(IV). Subsequently, the V(V) is replaced with fresh 1 M V(IV) solution, and the cell is charged at 100 mA cm⁻² to 1.7 V, discharged at 100 mA cm⁻² until 0.8 V, and charged at 100 mA cm⁻² for half the duration of the discharge to coulombically achieve the desired 50% SoC. 15 mL of posolyte and 15 mL of negolyte were used in VRFB full cell experiments. To determine the discharge polarization of the cells, the discharge current was increased at intervals of 20 mA cm⁻² followed by alternating charge at fixed 100 mA cm⁻² to return to 50% SoC, determined coulombically. For the rate study, the current density was increased from 100, 150, 200, 250, and 300 mA cm⁻², followed by a return to 100 mA cm⁻². Potential limits were set at 0.9 V while discharging and 1.7 V during charging to limit side reactions. Measurements were conducted with an Arbin battery tester (FBTS-8).

### Synthesis Procedure

We first provide a brief description of the generic NIPS process of forming membranes, and then hypothesize the mechanism driving the formation of the porosity gradient electrode. The NIPS process refers to the controlled precipitation of a dissolved polymer in a solvent by immersing the polymer-solvent mixture into a non-solvent bath, resulting in solvent-non-solvent exchange (i.e., demixing) and phase separation into scaffold-forming polymer rich and pore-forming polymer-poor phases. Accordingly, the resulting microstructure of membranes synthesized from NIPS is the result of an interplay between thermodynamic interactions and transport properties of the scaffold-forming polymer (PAN), additional pore-forming additives (PVP), solvent (DMF), and non-solvent (water). While a wide range of morphologies can be derived using the NIPS process, prior membrane characterization work has led to the identification of two distinct mechanisms which result in two distinct membrane morphologies: (I) instantaneous demixing to yield finger-like membranes, and (II) delayed demixing to yield sponge-like morphologies. In the first case (instantaneous demixing), macrovoid-containing structures have been observed when demixing is rapid; the formation of macrovoids frequently coincides with hydrodynamic flows, and depends on the solvent-non-solvent miscibility. Multiple theories for macrovoid formation have been proposed, including diffusion-based mass-transfer mechanisms where the faster onset of precipitation leads to macrovoids, or mechanical stresses at the solution-bath interface that initiate local surface instabilities and cause rupture points acting as nucleation sites for macrovoid formation followed by non-solvent convective flows into the blend, although the exact mechanism is still actively researched. Regardless, the morphology of this class of structures is typically characterized by a thin-top layer with large finger-like pores extending through the membrane thickness. In the second case (delayed demixing), it is posited that slow precipitation from delayed solvent-non-solvent exchange lead to the formation of macrovoid-free, sponge-like structures with more uniform porosity. While the thermodynamics and mass transport of polymers in a system with three or more components undergoing phase separation are quite challenging to model accurately, and the exact mechanisms of NIPS are still debated, generalizable principles indicate that more miscible solvent-non-solvent pairing, more compatible polymer-solvent coupling, and high polymer-concentration/viscosity tend to favor the formation of sponge-like structures. Accordingly, numerous factors can influence the resulting NIPS microstructure, including, but not limited to, the relative ratio of polymers, choice of solvent and polymers, total solids concentration, bath/casting temperature, and various additives to facilitate the phase separation process, impacting the phase separation process and interactions on different length scales.

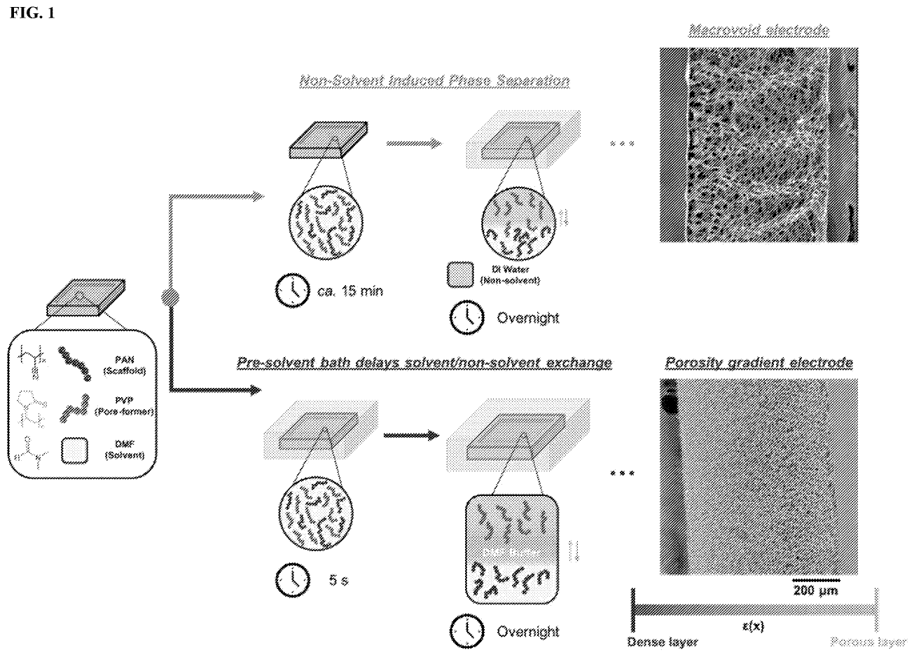

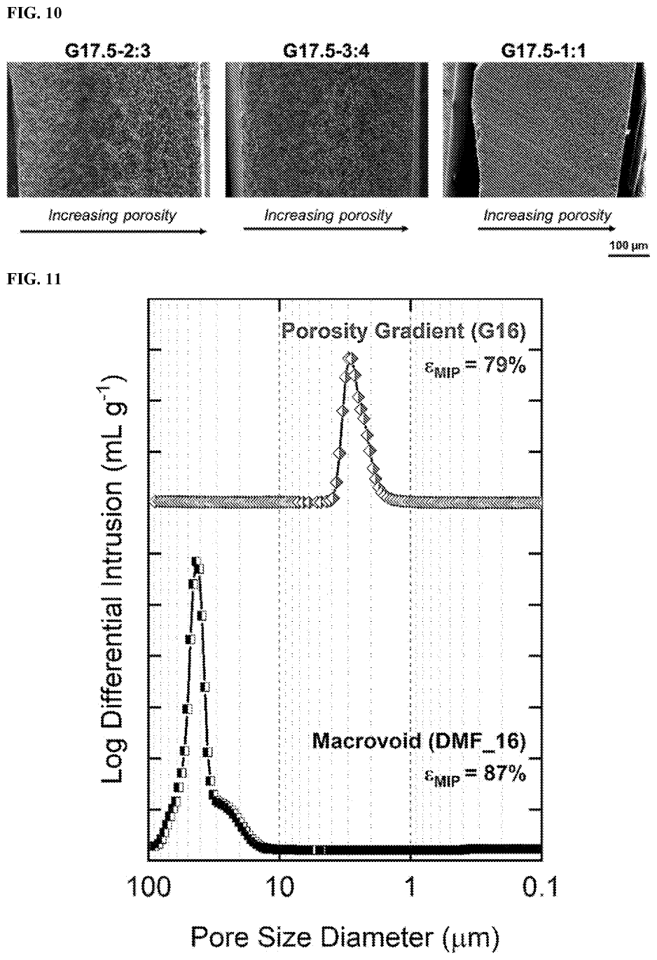

In our system, PAN is the scaffold-former, PVP is an additive, DMF is the solvent, and water is the non-solvent. We have previously shown the formation of macrovoid structures at various polymer concentrations, solvents, and bath temperatures. These materials from our previous work displayed polydisperse pore sizes with finger-like internal microstructure; further, the dense skin layer which adds resistance to the cell was removed using vapor-induced phase separation (VIPS) from the ambient environment prior to NIPS. We sought to synthesize a macrovoid-free porosity gradient electrode using the same solution compositions, as the reagents are common precursors used in the development of carbonaceous materials and would thus be compatible with existing scalable supply chains and infrastructures, although we posit the general paradigm could be applied to other combinations of polymers and solvents. To remove the macrovoids, we employ a solvent buffer layer by first immersing the casted polymers into a DMF bath for ca. 5 sec, and then transferring the assembly to the water bath to phase separate overnight. This pre-DMF bath improves the local miscibility of components at the interface of the casted solution and slows penetration of the non-solvent concentration front into the depth of the casted polymer solution in the mold. Furthermore, we posit that the addition of DMF prevents the creation of macrovoid-nucleating seeds which occur due to fluctuations in polymer/solvent/non-solvent concentrations that can precipitate macrovoids initiated near the bath/solution interface by smoothing the rapid change in non-solvent concentration, further inhibiting macrovoids. In essence, while it is outside of the scope of this current study to ascertain the precise mechanism by which macrovoid formation is suppressed, the introduction of a buffer zone addresses the most commonly posited theories, including delaying the demixing of solvent-non-solvent and mitigating stresses at the bath interface to prevent local nucleation sites from forming. Thus, without changing our formulation, we successfully achieve a macrovoid-free electrode with a porosity gradient; FIG. 1 shows the differences in the NIPS process and resulting microstructure between a representative macrovoid structure without the pre-buffering, and a representative porosity gradient structure with pre-buffering. Based on previous literature, we hypothesize that the observed increasing porosity from the bath-film interface to the film-mold interface spontaneously forms as a result of staggered precipitation pathways through the thickness of the film. Specifically, in sponge-like membranes, the surface of the casted film first undergoes rapid solvent-non-solvent exchange and polymer coarsening, forming smaller pores at the surface; the denser porous surface film subsequently restricts solvent-non-solvent exchange further down into the casted solution, facilitating a slower rate of precipitation and progressively larger pores formed.⁸¹ Here, we elect to focus on one specific formulation, specifically 0.18 g polymer/mL of DMF solvent with a PAN:PVP mass ratio of 2:3 casted at room temperature (ca. 21° C.), corresponding to the polymer blend with the lowest solids content in our previous study (16 wt % of polymer), as higher solids contents formed materials with low permeability insufficient to support flow without operational challenges such as electrolyte leaking (see FIG. 10 for SEMs of porosity gradient materials from polymer blends with higher solids content synthesized using the same pre-DMF methodology).

### Microstructural and Physicochemical Characterization

### Image Analysis of Porosity Gradient Microstructure

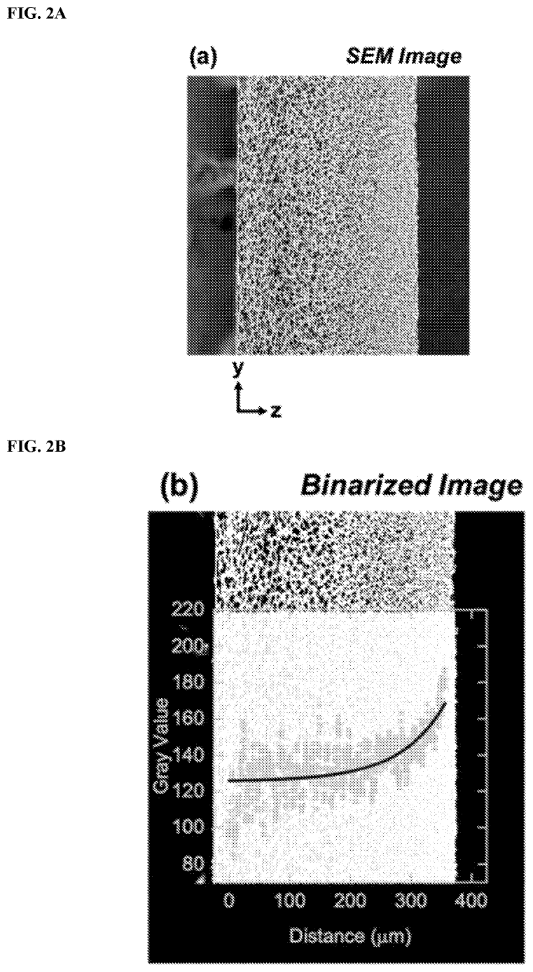

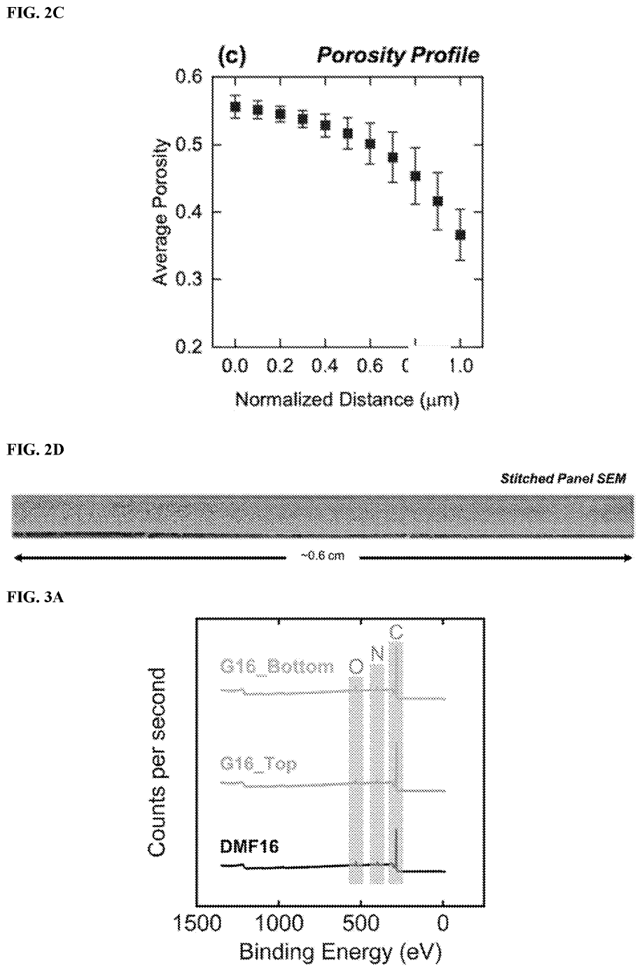

We next seek to characterize the microstructure of the resulting porosity gradient material. Scanning electron microscopy (SEM) of the porosity gradient electrode is shown in FIG. 2A, revealing a cross-section free of macrovoids and pore size decreasing when moving through the electrode thickness (i.e., the z-axis). While visual inspection suggests a gradually evolving electrode porosity in the through-plane direction, we quantify the porosity profile as a function of position through subsequent SEM image analysis. Full details of the procedure are described below. Briefly, the micrograph is first binarized via a thresholding process to yield the image with black and white pixels is shown in FIG. 2B. The average gray values along the y-direction (in-plane) as a function of the z-axis are determined and fit to an exponential with an offset, yielding GV (z), representing the solid matrix profile, which is then transformed to determine the average porosity. ϵ(z), using the relation

$$ϵ ( z ) = 1 - \frac{GV ( z )}{255} .$$

The compiled porosity profile as a function of normalized distance averaged across three independent samples is shown in FIG. 2C. To briefly comment on the reproducibility of the porous scaffold structure, the exact placement of pores at the micron scale is challenging because of the stochasticity of the pore formation process. However, as evinced from FIG. 2C, reproducibility is achievable at the length scale of the electrode thickness (ca. 0.5 mm). Moreover, the fluid dynamic and electrochemical performance of the electrodes are consistent across measurements (vide infra). We have observed similar unique microstructures but reproducible performance in our previous work. Thus, while further efforts may be beneficial towards reducing experimental error through automation or additional refinement, we maintain that the proposed synthesis procedure is sufficiently reproducible for the purpose of this study. We note that because the binarization procedure can be subject to variation, the averaged porosity profile should be considered as qualitative, and is useful as a general description of the profile achieved using DMF buffering during NIPS; the entire curve could be offset higher or lower depending on the thresholding procedure. Nevertheless, the results reveal a non-linear porosity profile with a gradient from a more porous layer to a denser layer. The magnitude of electrode porosity, which averages ca. 0.5 across the entire section, is on the lower end for electrode materials employed in RFBs, which tend to be around ca. 0.6-0.9. This also sets a practical upper bound for the solids content to be used for creating porosity gradients with this method, as higher solids fraction will lead to low porosity electrodes unsuitable for facilitating forced liquid convection without operational failure modes (see FIG. 10 for SEMs of porosity gradient materials with higher solids content). Coincidentally, the porosity profile in FIG. 2C is strikingly similar to the optimized electrode porosity profile proposed for performance improvement based on porous electrode theory in Li-ion batteries by Ramadesigan et al., suggesting potential for applying these electrodes in electrochemical systems aside from RFBs. It is important to note that porosities estimated through mercury intrusion porosimetry (MIP) and through density measurements are 0.79 and 0.89, respectively. While both measurements are also prone to inaccuracies, they reveal substantially higher than the porosity determined using image analysis. The discrepancy could result from internal porosity within the seemingly solid portion of the electrode, or because the 2D cross section does not account for the spatial arrangement of porosity into the plane of the cross section. Thus, the porosity determined using image analysis may be reflective of the effective porosity experienced by the electrolyte, as opposed to the actual porosity of the electrode in its entirety. To analyze the pore size distribution (PSD) of the porosity gradient electrodes, we perform MIP, shown in FIG. 10. The MIP results corroborates the SEM images regarding the characteristic pore size ranges, as the porosity gradient electrode exhibited 1-5 μm pores with a peak at ca. 3 μm, significantly smaller than the range of pores sizes for the macrovoid electrodes, which has an average pore size ranging from ca. 25-45 μm. Ultimately, the use of an electrode with lower porosity, interconnected, and porosity gradient microstructure impacts permeability, electrolyte flow paths, and electrochemical performance, respectively, and will be discussed in subsequent sections (vide infra). Lastly, to extend the field of view of the porosity gradient material, we performed stitched panel SEM, enabling construction of a wide-lens ˜0.6 cm view of the sample (FIG. 2D). The stitched panel micrograph reveals that the porosity gradient remains visible throughout the entire electrode, and furthermore, no macrovoids were formed during the phase separation process. Altogether, the image analysis demonstrates the robustness of the modified NIPS synthesis technique to procure macrovoid-free electrodes with exponentially decaying porosity profiles.

### Physicochemical Properties of Electrode Materials

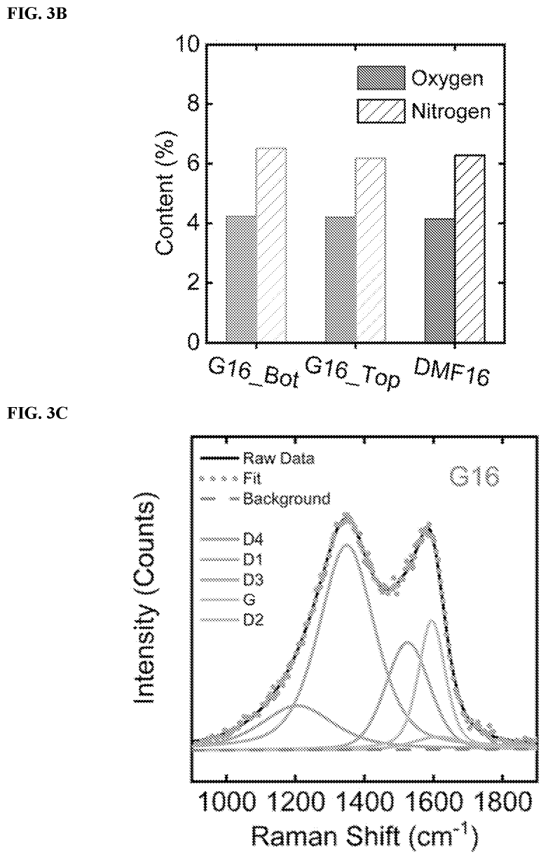

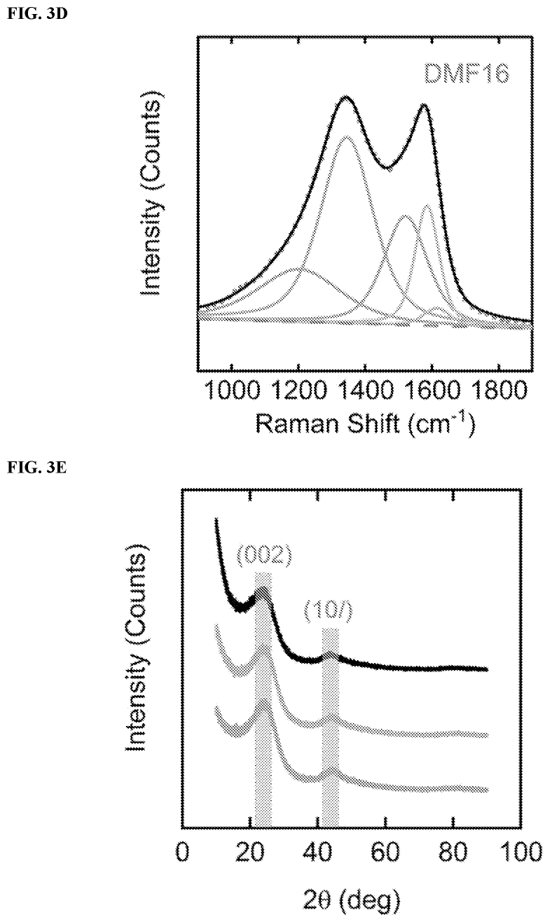

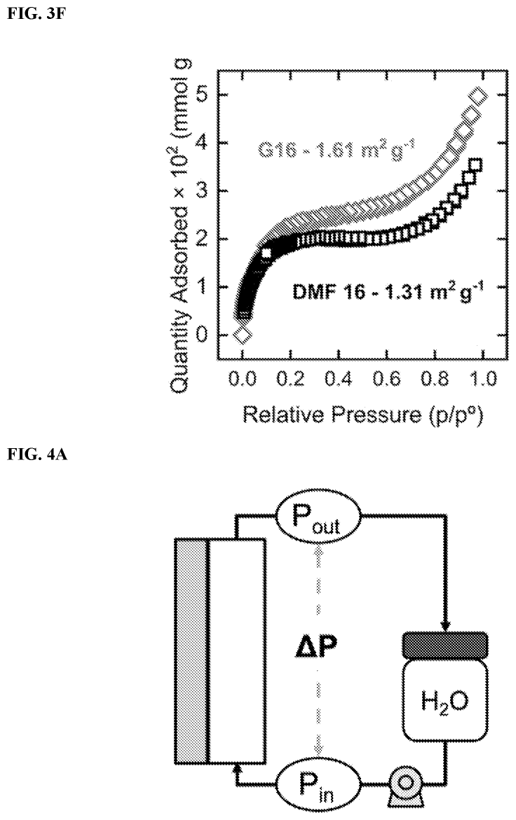

The electrode surface chemistry and functional groups are critical in augmenting or inhibiting various electron-transfer processes of relevance to RFBs. Thus, we next compare the surface chemistry and physical properties of both porosity gradient and macrovoid structures. The labeling convention for the electrodes is as follows: G stands for gradient, the number refers to the total polymer solids content as a percentage, and Bottom or Top refers to location of the membrane when casted in the mold. For the macrovoid-containing electrode, DMF stands for the solvent, but the number also refers to the total polymer solids content as a percentage. To identify the surface chemistry and binding environments of the materials, X-ray photoelectron spectroscopy (XPS) was performed, and survey scans of the bottom and the top of the porosity gradient material were compared to the macrovoid (FIG. 3A). A breakdown of the quantities of oxygen and nitrogen functionalities is shown in FIG. 3B. As expected, XPS demonstrates that the electrodes possess near identical elemental compositions, as they were produced from the same reagents, mixed in identical formulations, and annealed under the same processing conditions. Based on the XPS survey scan, the electrode materials were mostly carbon-; G16_Bottom (ca. 89.3 atomic %), G16_Top (ca. 89.6 atomic %), and DMF_16 (ca. 89.6 atomic %). All samples displayed similar amounts of oxygen and nitrogen functionalities; specifically, G16_Bottom contained ca. 4.2 atomic % oxygen and ca. 6.5% atomic nitrogen. G16_Top contained ca. 4.2 atomic % oxygen and ca. 6.2 atomic % nitrogen, and DMF_16 contained ca. 4.1 atomic % oxygen and ca. 6.3 atomic % nitrogen. The presence of both oxygen and nitrogen functionalities are anticipated based on the maximum carbonization temperature of 1050° C. used to synthesize the electrodes; greater degrees of carbonization could be achieved by increasing the maximum annealing temperature. A more detailed analysis and proposed deconvolutions of the high resolution C1s, N1s, and O1s spectra are shown in FIG. 12, with quantified values summarized in Table 1. Deconvolution of the C1s spectra reveals a breakdown of atomic content into bands corresponding to C═C (284.32±0.01 eV), C—C (285.00±0.01 eV), C—OH (286.02±0.01 eV), C═O (288.00±0.01 eV), O—C═O (290.06±0.02 eV), and π-π* (292.00±0.00 eV). Across all electrodes, the relative breakdown of the bands is similar, deviating by at most ca. 2.4 atomic % for any individual band. For example, the largest difference in relative atomic contribution of the C═C bonding environment for the G16_Bottom (ca. 46.3 atomic %), G16_Top (ca. 48.1 atomic %), and DMF_16 (ca. 47.1 atomic %) is 1.7 atomic %. Further details of the deconvolution for the C1s spectra described infra. The high-resolution Ols spectra can be resolved into two peaks, one corresponding to C sp²=O carbonyl groups (531.84±0.03 eV) and the other to C sp³-OH groups (533.30±0.00 eV).^{88,89} The carbonyl groups are of interest, as it has been hypothesized to enhance reaction rates of aqueous Fe^{2+/3+} electrochemistries in carbon surfaces. Across all three electrodes, the elucidated spectra showed a greater proportion of C sp²=((90.6±1.5 atomic %) as compared to the C sp³-OH (9.4±1.5 atomic %). Nitrogen functional groups have also been suggested as a catalyst for the vanadium redox reactions within RFBs. The deconvoluted N1s spectra show that for all the electrodes, most of the nitrogen functionalities are quaternary N (400.79±0.03 eV), or N substituting C in the graphitic plane. Graphitic N constitutes 42.2 atomic % of the nitrogen in G16_Bottom, 39.9 atomic % in G16_Top, and 43.5 atomic % in DMF_16. Pyridinic N (397.88±0.04 eV), pyrrolic N (399.50±0.00 eV), and oxidic N are also detected (403.26±0.15 eV), and are 30.4, 10.1, and 17.3 atomic % in G16_Bottom, 25.0, 18.5, and 16.7 atomic % in G16_Top, and 27.1, 11.5, and 17.9 atomic % in the DMF_16 electrode, respectively. In sum, the XPS results indicate that all synthesized electrodes possess substantially-similar surface chemistry; furthermore, the surface chemistry of the porosity gradient electrode does not significantly vary at least at its two outer surfaces, and all electrodes contain oxygen and nitrogen functional groups that could influence redox processes. This analysis also suggests that any discrepancies in performance (vide infra) cannot be attributed to differences in surface properties, as they are consistent across all samples.

We next quantify the degree of graphitization and defects at and near the electrode surface via Raman spectroscopy to compare materials properties. Of particular importance, the defects in the carbon bonding environments have been posited to impact electrochemical performance. Based on the XPS data indicating carbonaceous, amorphous carbons, we anticipate an array of vibrational states arising from the sp³-type bonds. Thus, we seek to compare the Raman spectra of the porosity gradient electrode to the macrovoid electrode. FIGS. 3C and 3D show that both materials exhibit broad peaks at the G band (ca. 1590 cm⁻¹) and D band (ca. 1347 cm⁻¹). The G band corresponds to a highly ordered graphite-like structure and C—C stretching vibration, whereas the D band corresponds to a disordered graphitic structure. Both materials exhibit a broad D peak, indicating more defects and amorphous carbon, with short-range ordered domains. Again, the intermediate degree of graphitization in the electrodes is expected given the maximum temperature used during its carbonization (i.e., 1050° C.) which is considerably lower than the temperature often used in commercial electrode synthesis (potentially up to 1400° C.). The broad D band is also observed in PAN-derived carbon materials fabricated by alternative means such as electrospinning. To quantify the degree of disorder, the Raman spectra were deconvoluted into five bands, using a mixed Gaussian and Lorentzian fit: D4 (ca. 1204 cm⁻¹), D1 (ca. 1347 cm⁻¹), D3 (ca. 1523 cm⁻¹), G (ca. 1590 cm⁻¹), and D2 (ca. 1615 cm⁻¹). From the fitted distributions of the bands, we use the ratio of the D1-band intensity to the G-band intensity (often denoted as the I_{D}/I_{G} ratio) to describe the degree of disordered defects to graphitized bonds. While informative, the I_{D}/I_{G} ratio is sensitive and subject to the parameters used to fit the data and may vary depending on the total number of peaks used. The I_{D} and I_{G} locations, widths, and intensity ratios for the three carbon materials are summarized in the Table 2, infra. Briefly, both the G16 and DMF_16 exhibit similar I_{D}/I_{G} ratios of 1.59 and 1.55, respectively, indicating the presence of vibrational modes corresponding to disordered defects in addition to graphitized bonds. As previously reported, the bottom-up synthesized materials exhibit patterns and vibrational modes more similar to certain commercial electrode offerings (e.g., Freudenberg H23 paper) than others (e.g., AvCarb 1071 carbon cloth), potentially reflecting discrepancies in carbonization or synthesis processes across all unique material sets. Perhaps most importantly, the similarity in Raman spectra between the porosity gradient and macrovoid electrodes suggest that surface defects are similar for each material and thus are unlikely to be the cause of differences in electrochemical performance. We probe the crystallinity of the electrodes by comparing their X-ray diffraction (XRD) patterns. As shown in FIG. 3E, diffractograms for G16_Bottom, G16_Top, and DMF_16 are nearly indistinguishable, with broad peaks at 2θ°=˜24.1° and ˜44.4°, corresponding to the (002) and (10l) atom planes. The d-layer interspacings are estimated as 3.68 Å for G16_Bottom, 3.67 Å for G16_Top, and 3.69 Å for the DMF_16 electrode, as determined by Bragg's equation applied to the 20° location of the peak corresponding to the (002) plane. The similarities between the diffractograms and d-layer interspacing further demonstrates the uniformity in crystallinity at both sides of the electrode and between electrode types.

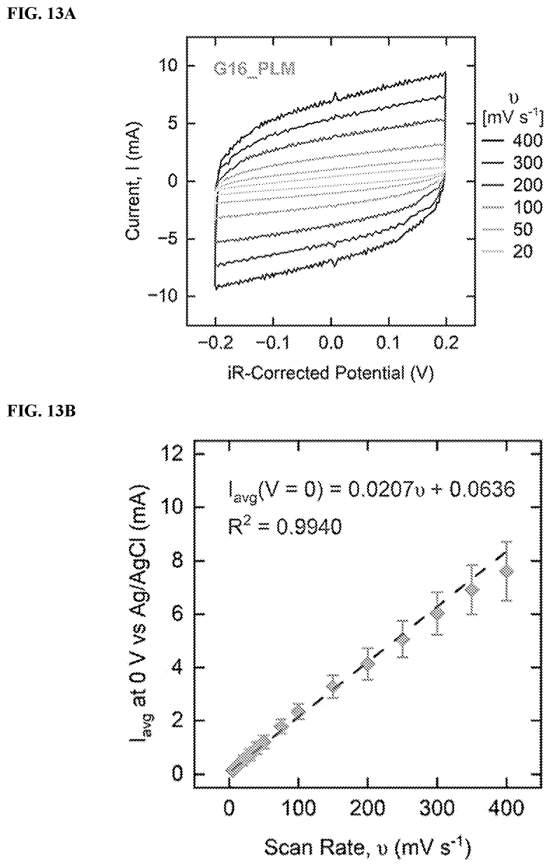

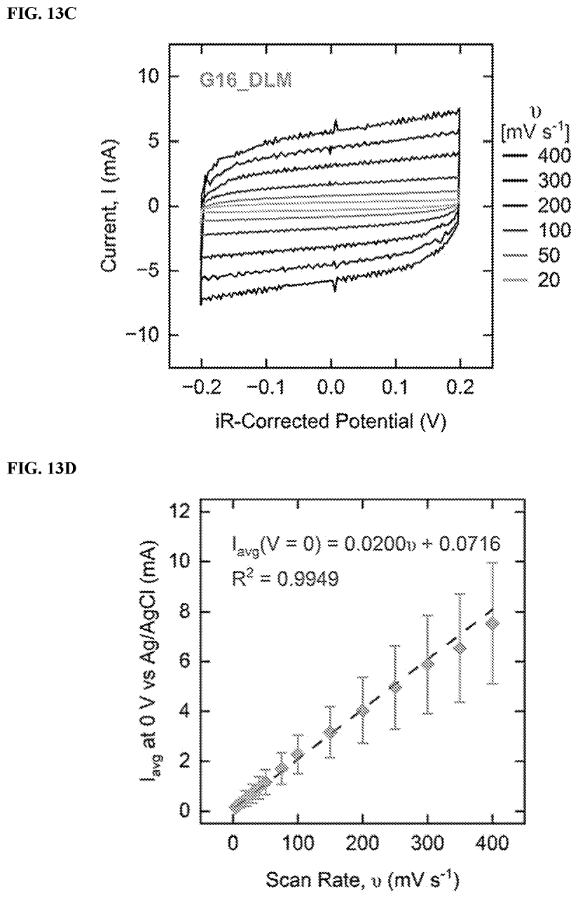

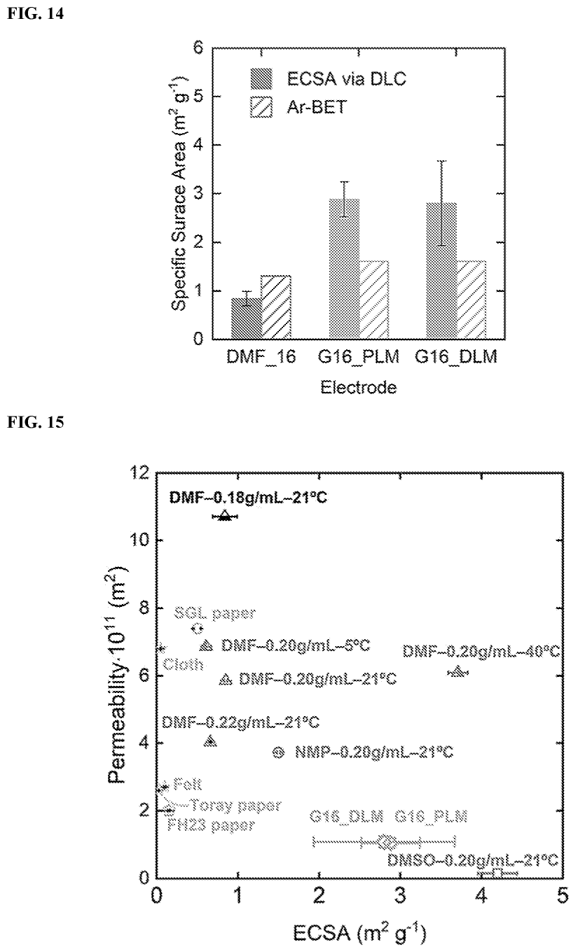

Lastly, we seek to approximate the specific surface area (SSA) of the electrodes using argon (Ar) physisorption; the isotherms of each electrode are shown in FIG. 3F. We note that these measurements can be sensitive especially when considering that non-thermally treated electrode interfaces tend to have smoother surfaces whose surface areas are non-trivial to estimate. We use Ar as the adsorbing gas, as it is considered to be more reliable than N₂ as a consequence of its minimal specific interactions with surface polar groups. We find that the G16 electrode exhibited a larger BET surface area of 1.61 m² g⁻¹ relative to the that of the DMF_16, which had a smaller BET surface of 1.31 m² g⁻¹; this is in agreement with the reduced porosity observed in SEM images of both electrodes (see FIG. 1). The Ar-physisorption indicates that the G16 electrodes have a ca. 23% higher SSA than the DMF_16 electrode, although we highlight that the surface areas observed here are on the same order of magnitude, and smaller than observed SSAs from gas physisorption of thermally oxidized substrates (i.e., 40-167 m² g⁻¹) that have been employed for use in RFBs. We note that the SSA here should be considered as a comparative measure, as alternative gases or gas mixtures can yield different SSA magnitudes. To estimate the electrochemically active surface area (ECSA), which may be more representative of the active surface area available for electrochemical reactions, we perform electrochemical double-layer capacitance (EDLC) on the porosity gradient materials in the single-electrolyte configuration, varying the direction of the porosity gradient (vide infra). We refer to the case where the porosity increases from the flow field to the membrane as G16_PLM, where PLM stands for “porous layer towards the membrane,” and we refer to the case where the porosity decreases from the flow field to the membrane as G16_DLM, where DLM stands for “dense layer towards the membrane.” Representative curves and further explanation of the methodology is provided in FIG. 13 and infra. Based on the EDLC measurements, we estimate SSAs of the G16_PLM and G16_DLM to be 2.88±0.36 and 2.80±0.87 m² g⁻¹, respectively. We previously determined an SS estimated through EDLC of 0.84±0.15 m² g⁻¹. Taken altogether, the EDLC data suggests the porosity gradient materials have much higher surface area (ca. 3.4×) than the macrovoid electrode, suggesting discrepancies between the surface area measurements. A graphical representation of the SSAs from BET and EDLC is shown in FIG. 14. Regardless of the measurement technique, the porosity gradient electrodes show higher SSA than their macrovoid counterparts, which we posit plays a significant role on kinetically limited RFB systems.

### Evaluation of Electrodes in Various Flow Cell Configurations

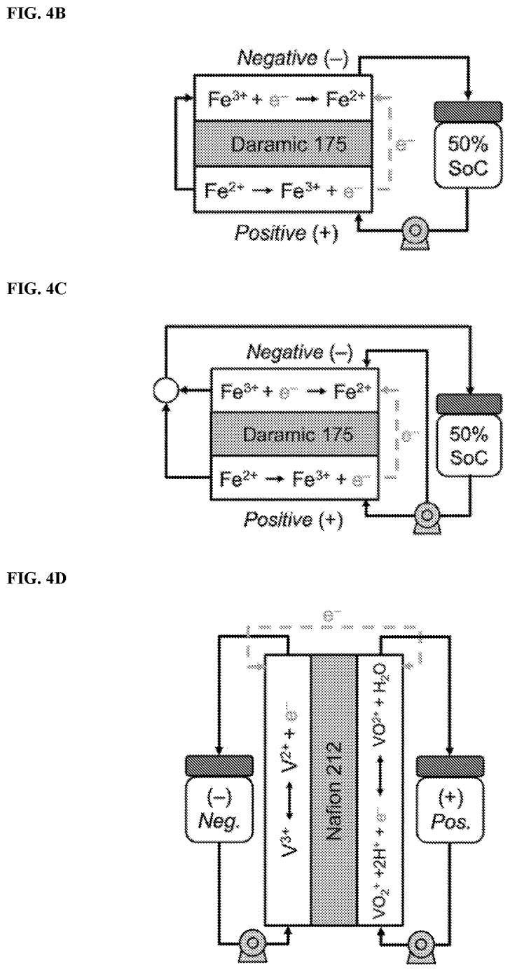

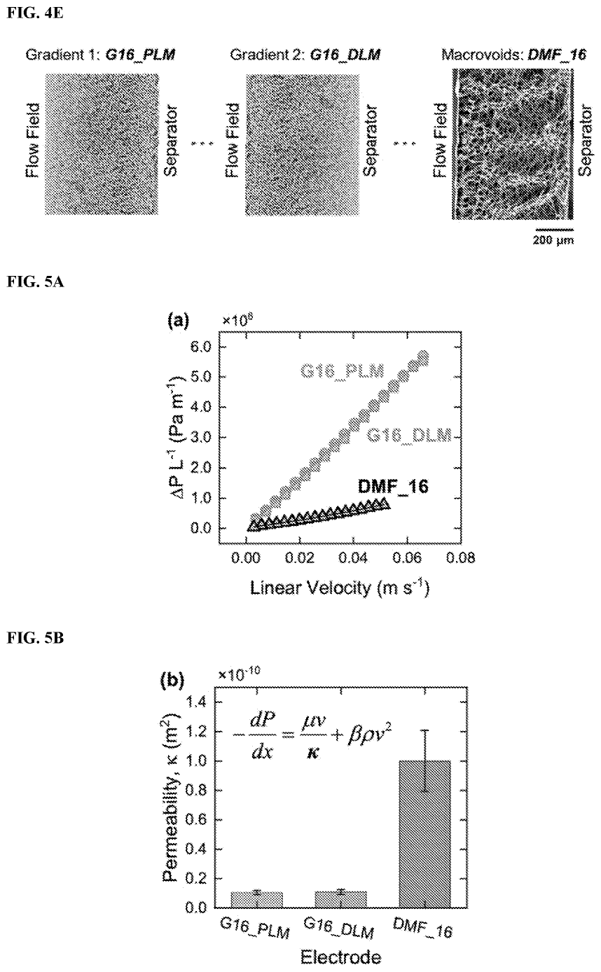

Next, we compare the fluid dynamic and electrochemical performance of the porosity gradient electrode with that of the macrovoid-containing electrode. To fully evaluate the electrodes, we use an array of cell configurations with differing working fluid and electrolytes. The different cell formats are shown in FIGS. 4A-4D, while the three electrode arrangements investigated here are summarized in FIG. 4E. Specifically, the three electrodes consist of two orientations of the porosity gradient materials and one arrangement of the macrovoid material. For the porosity gradient electrode, we refer to the case where the porosity increases from the flow field to the membrane as G16_PLM, where PLM stands for “porous layer towards the membrane,” and we refer to the case where the porosity decreases from the flow field to the membrane as G16_DLM, where DLM stands for “dense layer towards the membrane.”

### Assessing Electrode Permeabilities

We first examine the fluid dynamic performance of the set using pressure drop measurements using the setup illustrated by the schematic shown in FIG. 4A, where the effect of pressure drop across the electrode is measured by subtracting the inlet and outlet pressure as measured through gauges, and the difference gives the effective pressure drop through one electrode. FIG. 5A shows representative pressure drop measurements as a function of linear velocity of the working fluid, here water, through the electrode. To minimize differences in electrode thicknesses, we calculate the superficial electrolyte velocity, ν (m s⁻¹), using Equation (1):

$$v = \frac{Q}{{Nt}_{e} {w}_{e}} \qquad ( 1 )$$

Where Q is the volumetric flow rate (m³ s⁻¹), N is the number of inlet channels (−), tₑ is the compressed electrode thickness (m), and wₑ is the electrode width (m). Generally, the porosity gradient electrodes were thinner than their macrovoid counterpart as measured using a dial thickness gauge, with thicknesses of 468.3±21.7 μm and 575.5±11.2 μm, respectively. We posit the ca. 18.6% reduction in thickness for the porosity gradient electrode when compared to the macrovoid electrode despite casting into the same mold geometry stems from the first immersion into the DMF bath prior to non-solvent intrusion, lowering the local polymer concentration and viscosity at the bath-polymer interface, and resulting in thinner electrodes. While prior reports elect to account for electrode porosity to describe electrolyte velocity as an interstitial velocity through the pores, we choose not to do so here due to the complexity of the porosity profiles and spatial variation of the porosities in the present study, rendering interpretation of the interstitial velocity cumbersome. From FIG. 5a, it is clear that regardless of the direction of the porosity gradient material, the permeability is lower than that of the DMF_16. Interestingly, both the G16_PLM and G16_DLM exhibit nearly identical pressure drop despite having opposite porosity profiles. To further investigate the difference in permeabilities of the electrode set, we fit the raw data to a one-dimensional Darcy-Forchheimer expression relating the pressure drop to the bulk averaged permeability, «, Equation (2):

$$\frac{- dP}{dx} = \frac{μ v}{κ} + βρ {v}^{2} \qquad ( 2 )$$

Where P is the pressure (Pa), x is the position coordinate (m), μ is the dynamic viscosity (Pa s), β is the Forchheimer coefficient (m⁻¹), which accounts for inertial effects in the fluid flow, and ρ is the fluid density (kg m⁻³). A table summarizing the extracted effective permeabilities and Forccheimer coefficients are provided in Table 3 infra. Using this fit, we determine the effective permeability to be (1.05±0.15)×10⁻¹¹, (1.09±0.17)×10⁻¹¹, and (1.00±0.21)×10⁻¹⁰ m² for the G16_PLM, G16_DLM, and DMF_16, respectively (FIG. 5B). We note that the results for the DMF_16 are in consonance with our previous work on NIPS electrodes, which displayed permeabilities O(10⁻¹⁰-10⁻¹¹ m²), as well as fibrous electrodes used in RFBs, which exhibited permeabilities spanning O(10⁻¹⁰-10⁻¹² m²). Importantly, while the permeabilities of the porosity gradient materials are an order of magnitude lower than that of the macrovoid material, they are still within reasonable values for practical operation. The tradeoff between permeability and ECSA is illustrated in FIG. 15, which further contextualizes the values in this study to those of our previously examined NIPS electrode materials and commercially available fibrous electrodes. The interdigitated flow fields used in this study lead to lower pressure drops than other configurations; we leave the investigation of pairing porosity gradient electrodes with alternative flow field configurations to future studies.

### Electrochemical Evaluation in Iron Chloride Single-Electrolyte Flow Cell

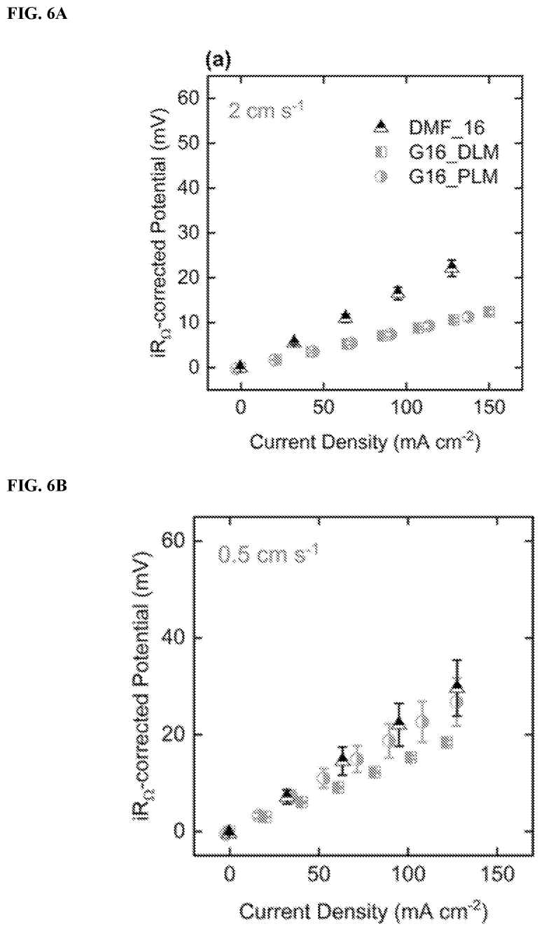

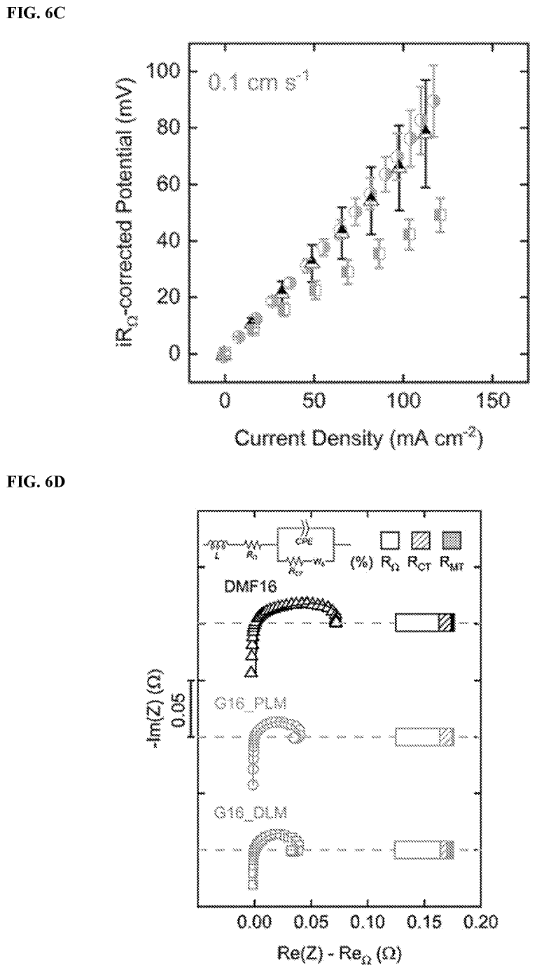

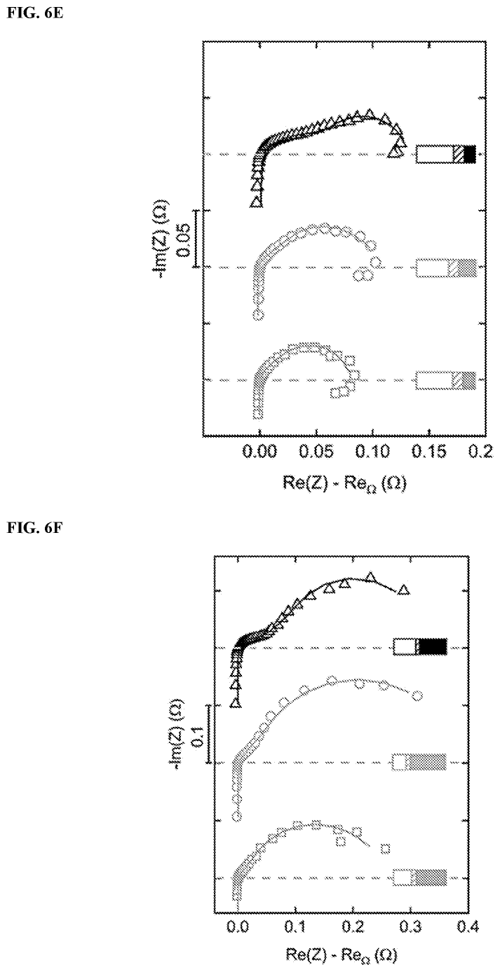

To evaluate the electrochemical performance of the electrodes, we employ a single-electrolyte flow cell configuration to measure polarization to ascertain total resistance and electrochemical impedance spectroscopy (EIS) to ascertain the sources and relative magnitudes of the resistive losses. As described in previous reports, in the single-electrolyte configuration (FIG. 4B), electrolyte is pumped from a reservoir into the positive electrode where it is oxidized, circulated into the negative electrode where it is reduced, and returned to the same reservoir. It is thus a convenient approach to evaluating cell performance characteristics a function of constituent components and operating conditions while maintaining a 50% state-of-charge (SOC) and minimizing the complexes of cycling a full cell (i.e., crossover, capacity fade) which can interfere with data analysis. To focus on kinetic and mass transport resistances, we approximate ohmic contributions as the product of the current, i, and the high-frequency intercept of the Nyquist plots from EIS, R_{Ω} (vide infra), and subtract the product from the polarization curves. The iR_{Ω}-corrected polarization curves of the three different electrode arrangements at three different linear velocities of 2, 0.5, and 0.1 cm s⁻¹ in 0.25 M Fe²⁺ and 0.25 M Fe³⁺ in 2 M HCl are shown in FIGS. 6A-6C. Here, we choose iron chloride as a model redox compound due to its moderately fast kinetics and chemical reversibility, ideal for reducing activation overpotential, enabling interrogation of mass transfer overpotential; further, the behavior of the redox couple within RFBs is relatively well-understood as it has used in a several practical embodiments of the technology (e.g., Fe—Cr RFB, hybrid all-Fe RFB). At the highest flow rate of 2 cm s⁻¹, the G16_PLM and G16_DLM electrodes show identical polarization behavior, both outperforming the DMF_16 electrode. The insensitivity of cell performance to the direction of the porosity gradient is hypothesized to be a consequence of the higher linear velocity combined with the interdigitated flow field, which directs fluid velocity components in at least two directions, which may enable a more uniform velocity profile independent of porosity gradients. We posit that the lower permeability porosity gradient materials outperform the higher permeability DMF_16 as permeability tends to be inversely related to mass transfer. We have previously shown that pore size distribution and cell performance tend to also be inversely related in both NIPS materials and carbon papers, which we attribute to higher local electrolyte velocities and shorter diffusion lengths within smaller pores, though we acknowledge additional features of the pore network will also affect fluid dynamics and reactive transport. At an intermediate flow rate of 0.5 cm s⁻¹, the G16_DLM exhibits the lowest resistances, followed by G16_PLM, and then DMF_16. At the lowest flow rate used in this study. 0.1 cm s⁻¹. G16_DLM again outperforms the DMF_16 and G16_PLM; thus, there is a shift in the performance trend as a function of linear velocity. We rationalize that for the G16_PLM, performance rapidly decreases with increasing flow rate because the dense layer facing the flow field becomes an increasingly difficult barrier to penetrate at lower flow rate, and thus local pressure differentials in the channels/electrode prevent full electrode utilization. A similar phenomenon has been discussed in a simplified 2D COMSOL model, albeit for VRFBs, which found that at constant pressure across the electrode (i.e., non-uniform local velocities more likely to occur at lower flow rates), linearly increasing porosity from the flow field to membrane resulted in worse performance than spatially invariant porosity and linearly decreasing porosity from the flow field to the membrane. We note that the average porosity of the G16 electrodes in our study is lower than that of typical electrodes (vide supra), which can challenge quantitative comparisons. However, these polarization results show the importance of electrolyte flow rate on the relative performance of the electrodes.

We further analyze the breakdown of resistances by fitting Nyquist plots obtained from EIS measurements, conducted about the operating circuit potential, at different electrolyte flow rates to a modified Randles equivalent circuit model (ECM) with a constant phase element (CPE) and bounded Warburg diffusion, shown in FIG. 6D-6F. In this circuit. L corresponds to inductance from the leads used to connect to the flow cell in the experimental setup. R_{Ω} corresponds to the ohmic resistance, CPE corresponds to the effective double-layer capacitance. R_{CT} corresponds to the charge-transfer resistance, and R_{MT} extracted from the Warburg element for convective diffusion, W_{δ}, corresponds to the mass-transfer resistance. We note that an ECM is a useful technique to approximate the cell response as a collection of discrete circuit elements representing known physical processes in the cell; however, this approach is not grounded in a first-principles physical basis, and multiple ECMs could be used to adequately fit the data with alternate physical interpretations. Thus, the fits in the present work are intended to semi-quantitatively capture the relative resistance breakdowns across the three porosity profiles as a function of linear velocity. We acknowledge the presence of low frequency loops crossing the −Im(Z) axis at 0.5 and 2 cm s⁻¹ flow rates for the G16_PLM and G16_DLM. Similar inductive features have been observed in PEMFCs and have been attributed to side reactions with intermediate species, water transport in the system, or transient catalyst layer proton conductivity. In the present work, we elect not to fit the low inductance loop, although future work should focus on determining the mechanisms leading to the anomalous behavior through physics-based modeling. R_{Ω} for the three electrodes are all comparable, yielding values of ca. 0.15±0.03, 0.28±0.20, and 0.24±0.01Ω (0.39±0.07, 0.72±0.50, and 0.62±0.04 Ω cm²) for the G16_PLM, G16_DLM, and DMF_16, respectively, although the measured resistances are only partly due to the effective conductivity resulting from the electrode matrix, and may vary for individual cell builds or lab-specific cell designs. Corroborating the polarization results, the Nyquist plots evince the same shift in performance trend of the electrodes with flow rate. Initially, at 2 cm s⁻¹, the G16_PLM and G16_DLM show nearly identical spectra, while the DMF_16 shows overall larger resistance. At 0.5 cm s⁻¹, the resistance gap between G16_PLM and DMF 16 becomes closer, whereby G16_DLM has clearly lower kinetic and mass transport resistance. Finally, at 0.1 cm s⁻¹. G16_PLM has a slightly higher resistance than DMF_16, and G16_DLM is the best performer. Again, these results are consistent with those observed in the iR_{Ω}-corrected polarization curves. A breakdown of R_{CT} and R_{MT} from the ECM fittings for the electrodes with varying flow rate is shown in FIG. 13, and a summary of the parameters extracted from the ECM fit as well as fit quality, are provided in Table 4. For all electrodes, the R_{CT} remains within a factor of two irrespective of flow rate, in consonance with expectations that reaction rate should be independent of flow rate. However, we observe a significant increase in R_{MT} with decreasing flow rate and G16_PLM appears the most sensitive to flow rate; semi-quantitatively, the ratio between R_{MT} at 0.1 cm s⁻¹ to R_{MT} at 2 cm s⁻¹ is ca. 67×, 15×, and 12× for G16_PLM, DMF_16, and G16_DLM. This strong dependence on flow rate for the G16_PLM may ultimately be responsible for the relatively higher resistances at low flow rate.

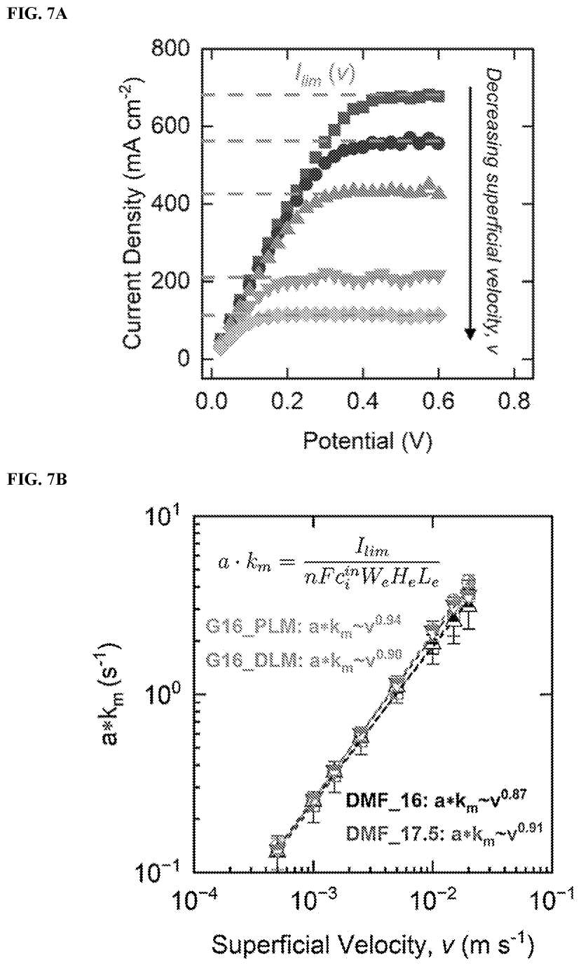

To further probe the effect of mass transfer in these electrodes, we perform limiting current experiments to measure the oxidation of Fe²⁺ in the symmetric cell configuration shown in FIG. 4C with an electrolyte composed of 0.05 M Fe²⁺ and 0.75 M Fe³⁺ in 2 M HCl supporting electrolyte. In this configuration, the electrolyte is drawn from the reservoir, split and passed through both half-cells, before being recombined at the outlet and returned to the reservoir, thus conserving SOC and evaluating the limiting oxidation of Fe²⁺. This version of the single-electrolyte cell is desirable for this set of experiments because the SOC of the electrolyte entering both electrodes is guaranteed to be same even when the applied currents are high, mitigating effects of electrolyte conversion through the electrode in the span of a single pass. A representative set of data from a limiting current experiment is shown in FIG. 7A. In this experiment, at a given flow rate, the potential is increased and held stepwise until the current density plateaus at a limit, where mass transfer of reactant to the electrode surface restricts the current from increasing. By varying the flow rate, we can determine how the limiting current, Iₗᵢₘ(A), and the mass transfer coefficient, kₘ (m s⁻¹), relate to each other via a control volume balance over the electrode length as shown in Equation (3):

$$a \cdot {k}_{m} = \frac{{I}_{lim}}{{nFc}_{i}^{bulk} {w}_{e} {t}_{e} {l}_{e}} \qquad ( 3 )$$

Where a is the volumetric surface area (m² m⁻³), n is the number of electrons transferred (−), F is the Faraday constant (C mol⁻¹),

$${c}_{i}^{bulk}$$

is the bulk concentration of the species being oxidized (mol m⁻³), and lₑ is the length of the electrode (m). It is worth noting an alternative formulation that is commonly employed to determine mass transfer coefficients derived from mass conservation in the electrode, shown in Equation (4):

$$a \cdot {k}_{m} = - \frac{v}{{l}_{e}} ln ( 1 - \frac{{I}_{lim}}{{nFc}_{i}^{bulk} {w}_{e} {t}_{e} v} ) \qquad ( 4 )$$

In this approach, it is assumed that there is a uniform concentration profile across the width of the electrode, and the mass conservation equation is integrated along the length of the electrode and related to the limiting current to yield an expression for the mass transfer coefficient. As both Equation (3) and Equation (4) yield nearly identical values for the results in this work, we elect to use the control volume approach to analyze the mass transfer coefficients. While both expressions require assumptions about the reactant concentration throughout the electrode, the mass conversation approach assumes a uniform concentration profile across the electrode width, which is unlikely given the flow field used in our study, whereby velocity bas at least two components directed in the channels and under the ribs. We also note that in this representation of the mass transfer coefficient, we opt to show the multiplicative product of a·kₘ instead of determining a and calculating kₘ in isolation, as the value for a is difficult to accurately estimate. FIG. 7B shows a·kₘ as a function of superficial velocity for the G16_PLM, G16_DLM, DMF_16, and DMF_17.5 (higher solids content macrovoid electrode). Overall, all four electrodes have similar power-law dependence between a·kₘ and ν, specifically 0.94, 0.90, 0.87, and 0.91 for the G16_PLM, G16_DLM, DMF_16, and DMF_17.5, respectively. Furthermore, while the values for a kₘ are generally in close proximity, the G16 PLM shows higher a·kₘ at higher superficial velocities (1.0-2.0 cm s⁻¹) than any of the other electrodes in this set, while the performance for all the electrodes collapses onto the same point at lower superficial velocities (0.05-0.5 cm s⁻¹), contrary to the results observed in the single-electrolyte study. The dependence of mass transfer coefficient on electrolyte velocity for the NIPS electrodes in this study appear to be similar to those of fibrous materials: for brevity, comparisons of the porous medium, limiting current redox couple, reactor specifications, correlations, mass transfer scaling, and methods of limiting current determination are summarized in Table 5. We note that drawing conclusions about generalizable mass transfer from these limiting current measurements is challenging because this set of experiments only examines the system response at steady state for one reactant concentration and for one redox reaction (i.e., Fe²⁺ oxidation). Future work should be conducted to further analyze the mass transport behavior of these materials under varying concentrations, conditions, and flow rate ranges to better optimize porosity profiles for improved electrode performance.

Electrochemical Evaluation in an all-Vanadium Flow Cell

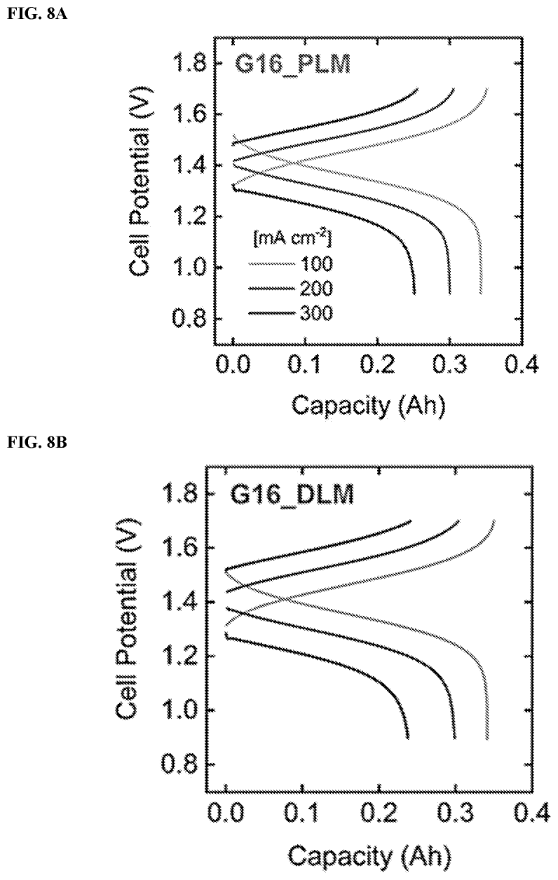

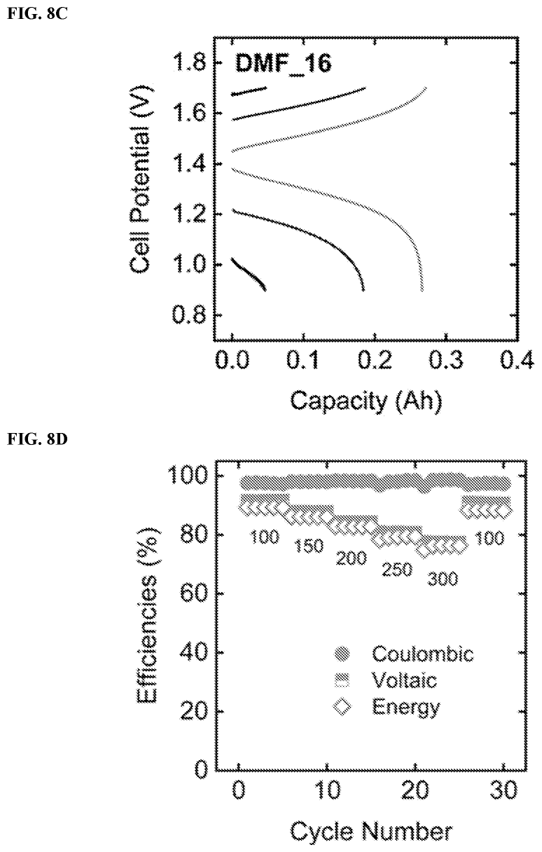

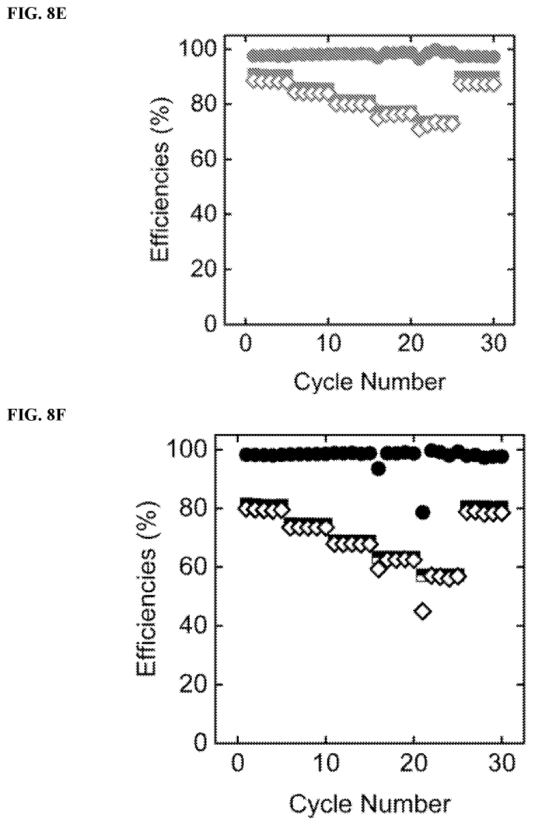

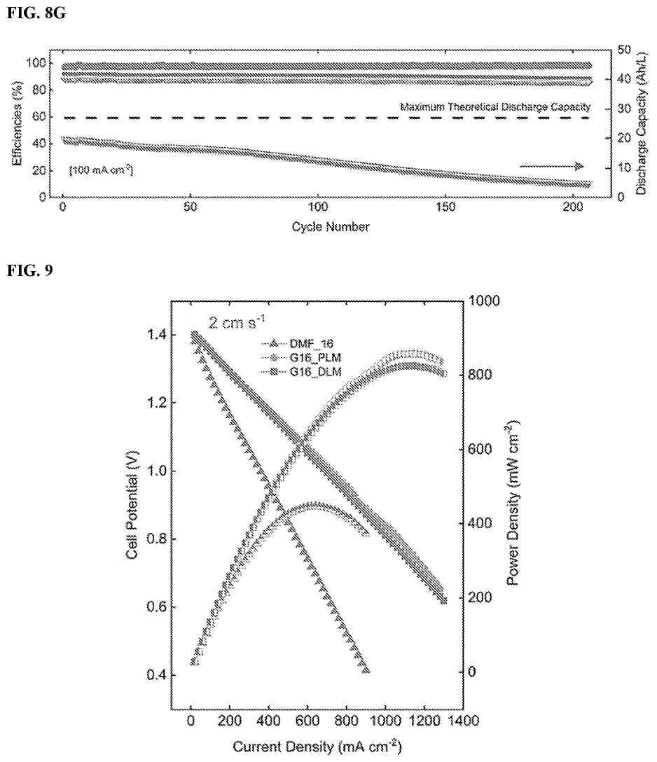

We next assess the performance of the porosity gradient electrodes in VRFB full cells s, arguably the state-of-the-art RFB chemistry. In contrast to the moderately fast reaction kinetics of the aqueous iron chloride couple on carbon surfaces, the vanadium redox reaction kinetics are generally observed to be sluggish on carbon surfaces. We first compare the performance of G16_PLM. G16_DLM, and DMF 16 via a rate study where the flow cell is galvanostatically cycled at five different current densities of increasing magnitude (100, 150, 200, 250, and 300 mA cm⁻²) and the returned to the first current density (100 mA cm⁻²), to evaluate performance recovery after high-rate cycling, with five charge/discharge cycles per current density. An electrolyte composition of 1.0 M vanadium in 3.0 M H₂SO₄ was chosen to demonstrate the practical application of the porosity gradient electrodes in VRFBs. Experiments were performed at a flow rate of 2 cm s⁻¹ to identify the upper bound of VRFB performance in the operating conditions used in this study. Charge/discharge curves and corresponding efficiencies for the flow cells with the three different electrode arrangements are shown in FIG. 8. Under this set of flow rates, flow fields, and electrolyte composition, the G16_PLM demonstrated the highest overall energy efficiency at all current densities examined. Furthermore, porosity gradient electrodes outperformed the macrovoid counterpart by a significant margin (i.e., the performance of the cells with G16_PLM and G16_DLM is superior to the performance of the cell with DMF_16). Across all cycles, the average coulombic efficiencies of G16_PLM, G16_DLM, and DMF_16 were comparable, achieving ca. 97.9±0.6%, 98.0±0.7%, and 97.6±1.1%, respectively. However, the G16_PLM and G16_DLM showed higher energy efficiencies at all current densities than the DMF_16. Specifically, at current densities of 100, 200, and 300 mA cm⁻², the G16_PLM achieved energy efficiencies of 89.3±0.1%, 82.8±0.1%, and 76.1±0.7%, as compared to that of the G16_DLM (88.3±0.2%, 79.8±0.1%, and 72.5±1.0%) and DMF_16 (79.6±0.3%, 67.9±0.1%, and 54.4±5.2%), respectively. Overall, the energy efficiency of the G16_PLM is ca. 21.7% higher than the DMF_16 at the highest current density, 300 mA cm⁻². As evinced in the aforementioned energy efficiencies, while G16_PLM and G16_DLM displayed similar performances, disparities gradually widened with increasing current density, whereby the G16_PLM demonstrated better rate capability by a small margin.

Bottom-up engineered electrode microstructures may be processed at lower carbonization temperatures which could render them susceptible to degradation modes during longer duration cycling. However, all electrodes showed strong recovery in the rate study when returning to the original 100 mA cm⁻², with a decrease of ca. 1% energy efficiency for all electrodes. To examine even longer duration stability, the best-performing G16_PLM electrode was cycled 206× at 100 mA cm⁻². The efficiencies remained relatively consistent when cycling. An average coulombic efficiency of ca. 97.8±0.4% and voltaic efficiency of ca. 89.5±0.9% was achieved, leading to an energy efficiency of 87.6±0.7%, with a ca. 2.2% reduction in energy efficiency from cycle 1 to 206 (FIG. 8G). The discharge capacity as a function of cycle number, shown in FIG. 8G starts at ca. 72.3% of the theoretical maximum discharge capacity of 26.9 Ah L-I and decays at a rate of 0.11% per cycle. The discharge capacity decay combined with the relatively steady efficiencies suggest that the G16_PLM electrode can perform reliably over a ca. 12.4-day span, although efforts to combat capacity decay through reduced crossover or rebalancing will still be necessary.

Discharge polarization further supports this trend observed in the rate study (FIG. 9). The maximum power densities of the G16_PLM, G16_DLM, and DMF_16 were ca. 858, 826, and 447 mW cm⁻², respectively. Thus, the porosity gradient materials attained significantly higher power densities, and the G16_PLM exhibited slightly higher power densities than the G16_DLM, which become more pronounced at elevated current densities (ca. >500 mA cm⁻²). Generally, the lower porosity and higher surface area porosity gradient materials performed better when compared to the more porous and lower surface area DMF_16. The results illustrate that for this cell geometry, electrolyte composition, and electrolyte flow rate, higher porosity facing the membrane leads to a slight advantage at higher current densities. We hypothesize that in the current distribution formed as a result of the sluggish vanadium redox reaction, higher porosity near the membrane combined with lower porosity at the flow field leads to increased local electrolyte velocities near the membrane, enabling greater flux of active species to be replenished as the driving force (i.e., current density) is increased. These findings are in agreement with a recent open-access preprint. Interestingly, the results in vanadium differ from the single-electrolyte iron chloride data, highlighting the nuance in guiding the better gradient profiles for unique circumstances. Overall, the porosity gradient materials are also characterized by lower porosity, higher surface area, and lower permeability than the DMF_16, which have been shown to lead to improved performance in VRFBs. Ultimately, the type of porosity gradient will have a significant impact on which direction of the gradient is definitively better for performance.

We briefly contextualize the results obtained for our porosity gradient material to a non-exhaustive set of recent studies in the VRFB literature, acknowledging that quantitative comparisons are challenged by differences in operating procedures, choice of cell component materials, and lab-specific flow cell reactor designs. A graphical comparison of energy efficiencies as a function of current density from these studies is provided in FIG. 14. Zhang et al. developed a N, P co-doped/reduced graphene oxide coated carbonized melamine foam electrode that yielded a 74.14% energy efficiency at a current density of 300 mA cm⁻². Deng et al. synthesized porous lamellar carbon from Bacillus mycoides to form an electrode for VRFBs, achieving a ca. 73.9% energy efficiency at a current density of 200 mA cm⁻². Park et al. used corn protein-derived particles on carbon felt electrodes to yield at energy efficiency of 68.6% at a rate of 150 mA cm⁻². Overall, the results presented in our work on porosity gradient materials appear comparable to presentations in prior literature, and may require less cumbersome and direct synthesis routes when considering scalable manufacturing processes.

### Cross-Sectional Scanning Electron Microscopy (SEM) of Denser Porosity Gradient Materials

Additional materials synthesized with higher solids content than those described above are shown in FIG. 10. The labeling convention is as follows: G stands for gradient, the number refers to the total polymer solids content as a percentage, and the ratio refers to the mass ratio between polyacrylonitrile (PAN) and polyvinylpyrrolidone (PVP). The solids content in these formulations is higher than those used in the main text by 1.5%. We further investigate the gradient of PAN:PVP ratios of 3:4 and 1:1. From the cross-sectional SEM images, it appears the porosity is insufficient to support forced liquid convection without significant pressure drop in aqueous flow batteries, although these materials could be suitable as transport layers in other electrochemical technologies requiring lower porosity scaffolds including Li-ion batteries, fuel cells, and electrolyzers.

### Mercury Intrusion Porosimetry (MIP) Pore Size Distribution Comparison

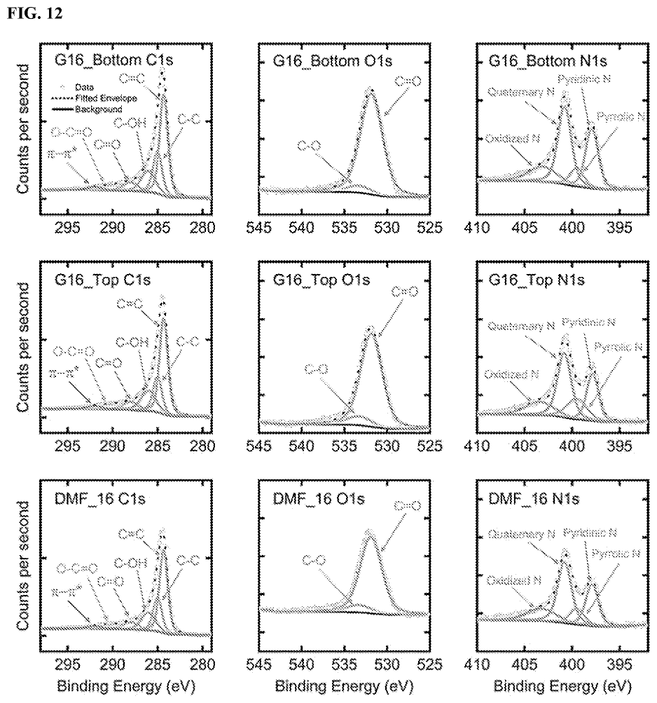

Microstructural analysis to determine the pore size distribution (PSD) of the porosity gradient and macrovoid electrodes are shown in FIG. 11. MIP analysis reveals the predominant PSD for the porosity gradient electrode ranges from 1-5 μm, with a peak at ca. 3 μm. This range of pore size is smaller than that of the macrovoid electrode, which has an average pore size that ranges from ca. 25-45 μm. The PSDs align with expectations based on the cross-sectional SEM images of the porosity gradient and macrovoid electrodes. Specifically, the porosity gradient electrodes do not contain any macrovoids and have visually smaller pores as compared to the DMF_16 electrode.

### High-Resolution X-Ray Photoelectron Spectroscopy (XPS) of Electrode Materials

Building upon FIGS. 3A and 3B in the main text, high resolution XPS is shown the C1s, O1s, and N1s spectra are shown for the DMF_16, G16_Top, and G16_Bottom electrode materials in FIG. 12. The C1s has been disaggregated into bands corresponding to C═C (284.32±0.01 eV), C—C (285.00±0.01 eV), C—OH (286.02±0.01 eV), C═O (288.00±0.01 eV), O—C═O (290.06±0.02 eV), and π-π* (292.00±0.00 eV). The Ols band has been elucidated into the C sp²=O group (531.84±0.03 eV) and the C sp³-OH band (533.30±0.00 eV). The NIs has been deconvoluted into pyridinic N (397.88±0.04 eV), pyrrolic N (399.50±0.00 eV), quaternary N (400.79±0.03 eV), and oxidic N (403.26±0.15 eV). A summary of the overall composition of the electrode and relative contributions of the bonding environments are provided in Table 1. As evident from the analysis, there is near identical surface chemistries across the different electrode types as well as the bottom/top surfaces, indicating the completeness of the carbonization procedure.

### Raman Spectra

A summary of the key parameters from Raman data shown in FIG. 3C, 3D are provided in Table 2. The peaks locations and widths of the I_{D} and I_{G} bands and the relative ratios of their heights for both the G16 and DMF_16 electrodes are given. The similar values of the peak locations, widths, and height ratios indicate the vibrational modes and thus degree of graphitization are similar between the two electrodes.

### Specific Surface Area (SSA) Measurements and Analysis

In addition to gas physisorption measurements, double-layer capacitance (DLC) was used as a proxy to estimate electrochemically accessible surface area (ECSA) under flow. In the single electrolyte configuration, we performed CVs on the porosity gradient electrodes in 3 M H₂SO₄ from −0.2 V to 0.2 V, sampling the regions least likely to promote Faradaic reactions. The capacitance, C_{DL} (F), is related to the average of the absolute value of the positive and negative current on the oxidative and reductive sweeps, respectively, at the cell potential of 0) V, I_{avg} (mA), and the scan rate u (mV s⁻¹), through Equation (5):

$${I}_{avg} = {C}_{DL} υ \qquad ( 5 )$$

In this formulation, the slope of I_{avg} versus o gives the capacitance. By dividing the capacitance of the porous electrode to a known specific areal capacitance on a representative surrogate flat surface, the ECSA can be estimated. Values in literature for the specific capacitance of GCEs in aqueous electrolytes typically range from 23-36 μF cm⁻².¹ Wan et al. that specific capacitance measured on dense carbon films with similar synthesis conditions and physicochemical properties is 26.1±4.0 μF cm⁻². To enable comparison with the estimated surface area of an array of NIPS electrodes in Jacquemond et al., we use the normalization basis of 23.0 μF cm⁻². FIG. 13 shows representative sets of scan rates and accompanying plots of current as a function of scan rate for G16_PLM and G16_DLM. The representative curves show capacitor-like behavior with resistance. Extracted values of the SSA estimated through DLC are compared to the SSA obtained through Ar-BET gas physisorption measurements in FIG. 14. The mass of a single electrode in the ECSA measurement was used to determine the SSA, as the DLC measurement is only measured on the working electrode. To construct FIG. 14, the ECSA via DLC from Jacquemond et al. for the DMF_16 was used. The Ar-BET for G16_PLM and G16_DLM are equivalent, since the difference between the two stems from the direction of the porosity gradient of the electrode from the flow field to the membrane. G16_PLM and G16_DLM both exhibit similar ECSA (2.88±0.36 and 2.80±0.87 m² g⁻¹, respectively), aligning with the similarity in fluid dynamic pressure drop experiments (FIG. 5). The DMF_16 exhibits a lower ECSA of 0.84±0.15 m² g⁻¹. The ECSA of the porosity gradient materials are ca. 3.4× that of the macrovoid material. The BET surface areas the porosity gradient materials are ca. 1.2× that of the macrovoid material, and thus, the magnitude in surface area discrepancy is comparatively lower for the gas physisorption measurement. The discrepancy between SSAs obtained through gas physisorption and DLC are expected given the distinctive manner by which measurements the measurements are performed; interestingly, the measurements in this work suggest that ECSA overpredicts SSA relative to Ar-BET, the reverse of previous observations in thermally treated electrodes. Ultimately, the porosity gradient electrodes show higher SSA than their macrovoid counterparts using both surface area estimation techniques.

Pressure Drop Measurements for Electrodes Coupled with Interdigitated Flow Fields

To investigate the differences in fluid dynamics through the electrodes, raw pressure drop data was fit to the one-dimensional Darcy-Forccheimer expression relating the pressure drop to the bulk averaged permeability, κ, as shown in Equation (2) of the main text, and repeated as Equation (6) for convenience:

$$\frac{- dP}{dx} = \frac{μ v}{κ} + βρ {v}^{2} \qquad ( 6 )$$

Where P is the pressure (Pa), x is the position coordinate (m), μ is the dynamic viscosity (Pa s), ν is the superficial fluid velocity (m s⁻¹), β is the Forchheimer coefficient (m⁻¹), and ρ is the fluid density (kg m⁻³). Table 3 summarizes the effective permeabilities and Forchheimer coefficients. The Forcheimer coefficient accounts for inertial effects in the fluid flow and deviations from ideal Darcy flow at higher Re number (i.e., flow rate). Overall, the three electrodes exhibit similar β within a factor of two, although the DMF_16 has an order of magnitude higher permeability.

### Mapping the Permeability and ECSA of Porosity Gradient Materials to the Literature

The permeability and ECSA of the porosity gradient materials are plotted against NIPS electrodes and commercial carbon-fiber electrodes gathered from our previous work, and is shown in FIG. 15. The other previous formulations from NIPS are shown in dark gray, and samples are named using the convention: Solvent-Polymer concentration (g/mL)-Temperature coagulation bath (° C.). For example, the DMF_16 sample in the present work is alternatively labeled as DMF-0.18 g/mL-21° C. in FIG. 15. The DMF_16 electrode shows the highest permeability, but relatively low ECSA. Comparatively, the G16_DLM and G16_PLM both show comparatively high ECSA, only exceeded by the DMF-0.20 g/mL-40° C. and DMSO-0.20 g/mL-21° C. We hypothesize that higher ECSA leads to improved performance in vanadium RFBs, as observed in the porosity gradient materials in this work and the DMF-0.20 g/mL-40° C. in our previous work. An important consideration from FIG. 15 is that the permeability, while low compared to the rest of the DMF-derived NIPS electrodes, is on par with Felt, Toray, and FH23 paper offerings.

### Breakdown of Equivalent Circuit Model (ECM) Fit to Nyquist Plots

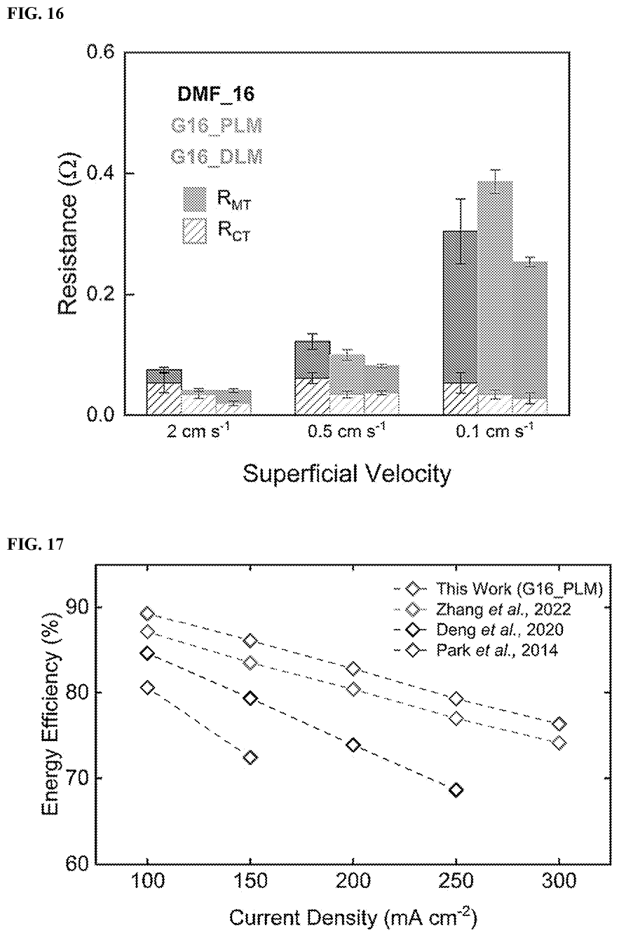

Expanding upon FIG. 6, we provide the breakdown of the resistances from fitting the equivalent circuit model (ECM) to the Nyquist plots derived from electrochemical impedance spectroscopy (EIS) of the G16_PLM, G16_DLM, and DMF_16 electrodes in the single-electrolyte configuration with 0.25 M Fe²⁺ and 0.25 M Fe³⁺ in 2 M HCl electrolyte. Specifically, the stacked and grouped bar chart shown in FIG. 16 displays the mass transfer resistance (R_{MT}) and the charge transfer resistance (R_{CT}) for the three electrodes at three different superficial velocities (2.0, 0.5, 0.1 cm s⁻¹); the ohmic resistance (R_{Ω}) is omitted in the analysis as it tends to vary depending on the specific cell build and convolutes the analysis. Thus, we typically apply iR_{Ω} correction to the cells during polarization analysis. At 2.0 cm s⁻¹. DMF_16 has the largest combined R_{CT} and R_{MT}, while G16_PLM and G16_DLM are nearly indistinguishable. At 0.5 cm s⁻¹. DMF_16 still has the largest combined resistance, but the combined resistance for G16_PLM is now in between DMF_16 and G16_DLM. Finally, at 0.1 cm s⁻¹, G16_PLM has the largest combined resistance, followed by DMF_16 and G16_DLM. These observations agree with the cell polarization results shown in FIG. 6a-c. The R_{MT} for the G16_PLM grows more quickly and to larger magnitudes than its counterparts as the superficial velocity decreases, suggesting that the smaller pressure gradient associated with the lower volume flow rate across the electrode leads to difficulties penetrating through the dense layer facing the flow field, thus leading to lower electrode utilization, and, in turn, poorer performance.

A summary of the parameters in the modified Randles ECM with a constant phase element (CPE) and bounded Warburg diffusion are provided in Table 4. In this circuit, L corresponds to inductance from the leads used to connect to the flow cell in the experimental setup. R_{Ω} corresponds to the ohmic resistance, Q corresponds to the CPE, γ corresponds to the dimensionless CPE order ranging from 0 to 1, R_{CT} represents the charge-transfer resistance, R_{MT} extracted from the Warburg element for convective diffusion, W_{δ}, corresponds to the mass-transfer resistance, and τ_{MT} is the diffusion time constant. Further, the range of the quality of the fits as determined using the χ² criterion is provided.

### Limiting Current Experiments in Iron Chloride

We expand upon the discussion on the limiting current experiments shown in FIG. 7 of the main text, further contextualizing the results presented in this study to other reports of fibrous materials found in the peer-reviewed literature. A summary of relevant porous electrode materials, corresponding mass transfer correlations, methods of analysis, and relevant operating conditions are provided in Table 5. Noticeably, direct quantitative comparison between studies is frustrated by the range of redox couples, supporting electrolyte compositions, flow fields, and methods of determination, all of which influence the transport phenomena within the electrode and reactions rates at the surfaces. Generally, redox couples with facile kinetics are employed, in tandem with asymmetric active species concentrations to assess the redox reaction of the active species of limiting concentration. The mass transport properties are often represented in the form of a dimensionless expression relating mass transport properties to Equations (7A-7D):

$$Sh = A \cdot {Re}^{α} {Sc}^{B} \qquad ( 7 a )$$

$$Sh = \frac{{k}_{m} {d}_{f}}{D} \qquad ( 7 b )$$

$$Re = \frac{ρ {vd}_{f}}{μ} \qquad ( 7 c )$$

$$Sc = \frac{μ}{ρ D} \qquad ( 7 d )$$

Where A, α, and B are dimensionless empirical coefficient which are determined by the fit, Sh is the Sherwood number (−) conveying the ratio of convective mass transfer rate to the molecular diffusion rate, Re is the Reynolds number (−) which is the ratio of inertial to viscous forces, Sc is the Schmidt number (−) conveying the ratio of viscous momentum to molecular diffusion, kₘ is the mass transfer coefficient (m s⁻¹), D is the diffusivity (m² s⁻¹), p is the fluid density (kg m⁻³), ν is the superficial velocity (m s⁻¹), and μ is the dynamic viscosity (Pa s). Here, the length scale for the dimensionless parameters is selected as the fiber diameter (d_{f}), following precedence in prior art as a characteristic pore-scale feature consistent throughout the materials. Further, it is worth highlighting that differing definitions of electrolyte velocity, specifically whether to include porosity in the calculation to omit the effect of the solid matrix (e.g., superficial velocity vs. pore-scale velocity), may also challenge direct comparison. However, further consideration should be taken when regarding what the proper length scale for polydisperse non-solvent induced phase separated (NIPS) electrodes (where there are no distinct fibers), a discussion which is outside the scope of this study. While alternative groupings of empirical relations to describe mass transfer rates exist, for the purposes of uniformity, we elect to focus the discussion and summary of the literature using the general paradigm introduced in Equation (S3), implying that mass transfer relates to velocity according to a power law described in Equation (8):

$$a \cdot {k}_{m} ▯ H \cdot {v}^{α} \qquad ( 8 )$$

Where H is an empirically fit coefficient, and a is the volumetric surface area (m² m⁻³). As discussed in the main text, we opt to show the multiplicative product of a·kₘ instead of determining a and calculating kₘ in isolation, as the value for a is difficult to accurately estimate. Based on this analysis, and combined with Equation 3 in the main text, we can contextualize our results to those found in the literature. The mass transfer scaling with velocity for our materials is slightly sub-linear, and ranges from 0.87-0.94 for the NIPS materials. This is in general agreement with experimentally observed scaling for a range of fibrous electrodes (i.e., carbon felts, papers, and cloths) which generally exhibit sub-linearities of 0.61-0.95. Aside from the diversity of electrode pore sizes and distributions, the variations could also be due in part to the choice of flow field, operating conditions, and/or model redox couple. Notably, direct numerical simulation on anisotropic electrospun materials led to an anomalously low scaling of 0.432, and a fitted model to carbon paper electrode single-electrolyte polarization with flow-through flow fields resulted in a 1.18 power relation between mass transfer rate and electrolyte velocity. Ultimately, the NIPS materials appear to display similar scaling, albeit at the higher end of observed mass transfer coefficients. Future work should seek to ascertain differences in porosity profile on mass transfer scalings with velocity.

### Comparing Performance of Porosity Gradient Electrode to the Literature

We provide a graphical comparison of our work to other non-electrospun bottom-up synthesized electrodes in the literature, using energy efficiency as a function of current density during galvanostatic charge-discharge as the performance metric. We acknowledge that direct quantitative comparisons are challenged by differences in experimental operating procedures, choice of cell component materials, and lab-specific flow cell reactor designs. FIG. 17 summarizes values from the averaged energy efficiency for G16_PLM of this work, Zhang et al. 2022, Deng et al. 2020, and Park et al. 2014.

### SUMMARY

Optimizing the porous carbon electrode microstructure is essential to achieving high energy efficiency and power density RFBs. Commercial electrode microstructures constrain the available design space of pore networks, necessitating the development of bottom-up engineered electrodes. Furthermore, unlike the macrohomogeneous properties of commercial offerings, porosity gradient electrodes may hold promise to effectively balance electrolyte distribution through the electrode while providing ample surface area in reaction-limited regions of the electrode. In this work, we demonstrate a versatile and bottom-up extension to the NIPS method to fabricate porosity gradient electrode microstructures derived from PAN by adding a buffer layer of DMF prior to the non-solvent phase separation step. Image analysis reveals the electrodes are characterized by monotonically and exponentially increasing porosity evolving from the bath/polymer interface to the polymer/mold interface, with an average porosity of ca. 0.5. Additionally, the electrodes are free of macrovoids on the sub-centimeter scale, in contrast to electrodes synthesized directly using NIPS without the buffer layer. Using the same polymer solution formulation, we compare the porosity gradient electrode to its macrovoid-containing counterpart. Materials characterization of the porosity gradient and macrovoid-containing electrodes show that the electrodes share similar crystallinity, vibrational properties, and surface chemistries, though the porosity gradient electrodes have slightly higher Ar-BET surface areas. We then compare the effect of the direction of the porosity gradient on fluid dynamic and electrochemical performance and benchmark the results to the macrovoid-containing electrode. We find that the porosity gradient electrodes have an order of magnitude lower permeability than the macrovoid electrode, and that interestingly, the direction of the porosity gradient does not affect the permeability; we attribute this to the use of IDFF flow fields, which accommodate flow in multiple directions for improved electrolyte distribution. In iron chloride single-electrolyte electrochemical measurements, we find the performance trends of the electrodes to be flow-rate dependent. Specifically, while the porosity gradient electrodes both equally outperform the macrovoid counterpart at high flow rate, the electrode with the lower porosity facing the flow field performs relatively worse at an intermediate flow rate and shows the highest resistances of the set at the lowest flow rate. We posit that the inability to penetrate the dense layer at the low flow rate may account for this anomalous phenomenon. We subsequently perform limiting current measurements in the symmetric cell configuration to further probe evaluate mass transport behavior in iron-chloride, ultimately finding similar performance between porosity gradient and macrovoid electrodes except minor deviations at high flow rates, where the lower porosity facing the flow field electrode outperforms the set. Subsequently, we evaluate the practical application of these electrodes in a full-cell VRFB, determining that the porosity gradient electrodes exhibit stellar energy efficiency and power density compared to the macrovoid electrode, and in good standing when contextualized to bottom-up engineered electrode efforts in the VRFB literature. To comment on the overall concept of what porosity gradients is most valuable in RFB electrodes, we highlight that the findings in this work are specific to the unique morphologies and properties generated from the NIPS method, which are on the lower end of porosity and permeability compared to fibrous commercial offerings. Of particular interest would be to see whether the dependence of performance on flow rate is also observed when expanding the bounds of the porosity limits in the gradient, as well as for differently profiled gradients or for electrodes with differently shaped and oriented pores. Altogether, these experimental results show that porosity gradient materials exhibit promising performance under specific circumstances; further detailed studies understanding the flow distribution through the materials will be necessary to identify optimal porosity distributions, either through computational approaches or further extensions to this method. Looking forward, this method offers a new platform which may be used to further explore porosity profiles of varying shape (e.g., linear, step-wise, quadratic) and amplitude (i.e., upper, and lower bounds). Further investigations in synthetic capabilities may enable articulation of the flow-rate dependent mass transport behavior observed in the present work to fully harness the potential of porosity gradient electrodes in RFBs and electrochemical systems more broadly.

TABLE 1
Summary of elemental composition from XPS for the
G16_Bottom, G16_Top, and DMF_16 electrodes.

| | G16_{—} | G16_{—} | DMF_{—} |
|---|---|---|---|
| | Bottom | Top | 16 |
| C (total) | 89.3 | 89.6 | 89.6 |
| O (total) | 4.2 | 4.2 | 4.1 |
| N (total) | 6.5 | 6.2 | 6.3 |
| C═C (284.32 ± 0.01 eV) | 46.3 | 48.1 | 47.1 |
| C—C (285.00 ± 0.01 eV) | 21.4 | 19.0 | 20.5 |
| C—OH (286.02 ± 0.01 eV) | 17.1 | 17.9 | 17.2 |
| C═O (288.00 ± 0.01 eV) | 7.5 | 7.4 | 7.6 |
| O—C═O (290.06 ± 0.02 eV) | 4.8 | 4.7 | 4.7 |
| π − π* (292.00 ± 0.00 eV) | 3.0 | 2.9 | 3.0 |
| O═C sp² (531.84 ± 0.03 eV) | 92.4 | 89.7 | 89.7 |
| O—C sp³ (533.30 ± 0.00 eV) | 7.6 | 10.3 | 10.3 |
| Pyridinic N (397.88 ± 0.04 eV) | 30.4 | 25.0 | 27.1 |
| Pyrrolic N (399.50 ± 0.00 eV) | 10.1 | 18.5 | 11.5 |
| Quaternary N (400.79 ± 0.03 eV) | 42.2 | 39.9 | 43.5 |
| Oxidic N (403.26 ± 0.15 eV) | 17.3 | 16.7 | 17.9 |

G refers to gradient, DMF refers to the solvent, and 16 refers to the total polymer solids content as a percentage. Relative contributions of the bonding environments corresponding to various bonding types for carbon, oxygen, and nitrogen are also shown. Deconvolutions and fitting protocols were performed based on prior literature: Carbon breakdown, oxygen breakdown, nitrogen breakdown, and fitting protocol.

TABLE 2
Summary of peak locations and widths of the D and
G bands extracted from the Raman spectra of the
porosity gradient and macrovoid electrode.

| | | I_{D} | | I_{G} | I_{D}/ |
|---|---|---|---|---|---|
| | I_{D} | width | I_{G} | width | I_{G} |
| Sample | (cm⁻¹) | (cm⁻¹) | (cm⁻¹) | (cm⁻¹) | ratio |
| G16 | 1349 | 192 | 1595 | 92 | 1.59 |
| DMF_16 | 1345 | 189 | 1585 | 87 | 1.55 |

The ratio between the heights of the I_{D}/I_{G} bands are also shown. N=1 for each electrode.

TABLE 3
Summary of the extracted effective permeabilities, κ, and Forchheimer
coefficients, β, from fits of the raw pressure drop data.

| Electrode | κ (m²) | β (m²) |
|---|---|---|
| G16_PLM | (1.05 ± 0.15) × 10⁻¹¹ | (7.74 ± 2.45) × 10⁴ |
| G16_DLM | (1.09 ± 0.17) × 10⁻¹¹ | (5.81 ± 3.59) × 10⁴ |
| DMF_16 | (1.00 ± 0.21) × 10⁻¹⁰ | (6.79 ± 2.42) × 10⁴ |

Interdigitated flow fields were used in the pressure drop setup. Experiments were repeated in triplicate (N=3) and the reported error is one standard deviation.

TABLE 4
Summary of parameters extracted from fitting the Nyquist plots
for iron chloride electrolyte to the modified Randles ECM.

| | G16_PLM | | | G16_DLM | | | DMF_16 | | |
|---|---|---|---|---|---|---|---|---|---|
| Parameters | 2 cm s⁻¹ | 0.5 cm ⁻¹ | 0.1 cm s⁻¹ | 2 cm s⁻¹ | 0.5 cm s⁻¹ | 0.1 cm s⁻¹ | 2 cm s⁻¹ | 0.5 cm s⁻¹ | 0.1 cm s ⁻¹ |
| L [H] | (1.08 ± | (1.09 ± | (1.09 ± | (1.20 ± | (1.20 ± | (1.19 ± | (1.08 ± | (1.08 ± | (1.07 ± |
| | 0.07) × | 0.08) × | 0.08) × | 0.04) × | 0.04) × | 0.04) × | 0.20) × | 0.19) × | 0.19) × |
| | 10⁻⁶ | 10⁻⁶ | 10⁻⁶ | 10⁻⁶ | 10⁻⁶ | 10⁻⁶ | 10⁻⁶ | 10⁻⁶ | 10⁻⁶ |
| R_{Ω} [ohm] | 0.15 ± | 0.15 ± | 0.15 ± | 0.28 ± | 0.28 ± | 0.28 ± | 0.24 ± | 0.24 ± | 0.24 ± |
| | 0.03 | 0.03 | 0.03 | 0.20 | 0.20 | 0.20 | 0.01 | 0.01 | 0.01 |
| Q [F s^{γ-1}] | 4.99 ± | 4.92 ± | 6.33 ± | 4.80 ± | 5.59 ± | 7.40 ± | 1.86 ± | 2.27 ± | 2.53 ± |
| | 1.37 | 1.38 | 0.38 | 0.30 | 0.92 | 1.00 | 0.77 | 0.05 | 1.87 |
| γ (—) | 0.76 ± | 0.76 ± | 0.72 ± | 0.84 ± | 0.86 ± | 0.76 ± | 0.60 ± | 0.56 ± | 0.59 ± |
| | 0.02 | 0.10 | 0.00 | 0.01 | 0.03 | 0.04 | 0.11 | 0.03 | 0.15 |
| R_{CT} [ohm] | 0.033 ± | 0.034 ± | 0.034 ± | 0.019 ± | 0.037 ± | 0.027 ± | 0.053 ± | 0.061 ± | 0.053 ± |
| | 0.006 | 0.005 | 0.007 | 0.004 | 0.003 | 0.009 | 0.016 | 0.009 | 0.017 |
| R_{MT} [ohm] | 0.0075 ± | 0.0657 ± | 0.3526 ± | 0.021 ± | 0.044 ± | 0.226 ± | 0.022 ± | 0.061 ± | 0.251 ± |
| | 0.0028 | 0.0087 | 0.0195 | 0.003 | 0.003 | 0.007 | 0.004 | 0.013 | 0.054 |
| τ_{MT} | 0.50 ± | 1.33 ± | 8.07 ± | 0.26 ± | 1.03 ± | 2.75 ± | 0.41 ± | 2.26 ± | 12.94 ± |
| | 0.29 | 0.25 | 0.04 | 0.01 | 0.22 | 0.12 | 0.03 | 0.95 | 7.84 |
| χ² (—) | (1.36 × | (1.14 × | (7.79 × | (3.31 × | (1.30 × | (1.32 × | (6.80 × | (1.27 × | (1.00 × |
| | 10⁻⁵)- | 10⁻⁵)- | 10⁻⁴)- | 10⁻⁵)- | 10⁻⁴)- | 10⁻³)- | 10⁻⁵)- | 10⁻⁴)- | 10⁻³)- |
| | (7.97 × | (3.50 × | (8.21 × | (4.03 × | (3.09 × | (4.49 × | (2.11 × | (2.83 × | (3.13 × |
| | 10⁻⁵) | 10⁻⁴) | 10⁻⁴) | 10⁻⁵) | 10⁻⁴) | 10⁻³) | 10⁻³) | 10⁻⁴) | 10⁻³) |

The range for the quality of the fits for the electrodes are provided. N=2 for each electrode.

TABLE 5
Summary of mass transfer correlations found in the literature
for fibrous electrode materials used as RFB electrodes.

| | Limiting | | | Geometric |
|---|---|---|---|---|
| Porous | Current Redox | Supporting | | Electrode |
| Electrode | Couple | Electrolyte | Flow Field | Area |
| Carbon Felt | 0.05M Fe²⁺ and | 2M HCl | Flow-through w/ | 5.0 cm × |
| (Hi-Tech, Inc.) | 0.75M Fe³⁺ | | electrolyte | 5.0 cm |
| | | | distributor | |
| Carbon Felt | 5.5 × 10⁻³ | 2M ZnBr₂ and | Flow-through | 1.0 cm × |
| (Fiber | to 6.2 × 10⁻²M | 1M ZnCl₂ in 3M | | 2.0 cm |
| Materials, Inc.) | bromine | KCl | | |
| Electrospun | — | — | — | — |
| Carbon Paper | 0.25M Fe²⁺ and | 2M HCl | Flow-through | 1.5 cm × |
| (SGL 25AA) | 0.25M Fe³⁺ | | | 1.7 cm |
| Carbon Paper | 0.25M Fe²⁺ and | 2M HCl | Interdigitated | 1.5 cm × |
| (SGL 25AA) | 0.25M Fe³⁺ | | | 1.7 cm |
| Carbon Paper | 0.5M Fe²⁺ and | 2M HCl + 0, 0.5, | Flow-through | 1.5 cm × |
| (SGL 29AA) | 0.5M Fe³⁺ | or 1.0M glucose | | 1.7 cm |
| Carbon Paper | 0.5M Fe²⁺ and | 2M HCl + 0, 0.5, | Interdigitated | 1.5 cm × |
| (SGL 29AA) | 0.5M Fe³⁺ | or 1.0M glucose | | 1.7 cm |
| Carbon Cloths | 3 mM TEMPO^{(·)} | 1M TEA-BF₄ in | Flow-through | 1.5 cm × |
| (AvCarb) | and 15 mM | MeCN | | 1.7 |
| | TEMPO⁽⁺⁾ | | | |
| This work | 0.05M Fe²⁺ and | 2M HCl | Interdigitated | 1.5 cm × |
| | 0.75M Fe³⁺ | | | 1.7 cm |

| Porous | | Scaling w/ | Method of |
|---|---|---|---|
| Electrode | Correlation | velocity | Determination |
| Carbon Felt | kₘ ~ v^{0.9} | 0.9 | Limiting current |
| (Hi-Tech, Inc.) | | | |
| Carbon Felt | Sh = 1.01Re^{0.61} | 0.61 or 0.72 | Limiting current |
| (Fiber | or | | |
| Materials, Inc.) | Sh = 1.29Re^{0.72} | | |
| Electrospun | Sh = 0.906 | 0.432 | Direct numerical |
| | Re^{0.432}Sc^{0.432} | | simulation |
| Carbon Paper | a · kₘ ~ v^{1.18} | 1.18 | Fitted model |
| (SGL 25AA) | | | |
| Carbon Paper | a · kₘ ~ v^{0.79} | 0.79 | Fitted model |
| (SGL 25AA) | | | |
| Carbon Paper | Sh = 0.004 | 0.75 | Fitted model |
| (SGL 29AA) | Re^{0.75}Sc^{0.51} | | |
| Carbon Paper | Sh = 0.018 | 0.68 | Fitted model |
| (SGL 29AA) | Re^{0.68}Sc^{0.50} | | |
| Carbon Cloths | a · kₘ ~ v^{0.66 to 0.95} | 0.66 to 0.95 | Limiting current |
| (AvCarb) | | | |
| This work | a · kₘ ~ v^{0.87 to 0.94} | 0.87 to 0.94 | Limiting current |

Supporting information relevant to the determination of the mass transfer correlation including the porous electrode evaluated, limiting current redox couple, supporting electrolyte composition, flow field, and method of determination are provided alongside the correlation and the mass transfer scaling with velocity.

### INCORPORATION BY REFERENCE

All U.S. patents and U.S. and PCT patent application publications mentioned herein are hereby incorporated by reference in their entirety as if each individual publication or patent was specifically and individually indicated to be incorporated by reference. In case of conflict, the present application, including any definitions herein, will control.

### EQUIVALENTS

While specific embodiments of the subject invention have been discussed, the above specification is illustrative and not restrictive. Many variations of the invention will become apparent to those skilled in the art upon review of this specification and the claims below. The full scope of the invention should be determined by reference to the claims, along with their full scope of equivalents, and the specification, along with such variations.

1. A method of fabricating a porosity gradient electrode, the method comprising
preparing a single-phase mixture of a scaffold-forming polymer, a pore-forming additive, and a solvent;
casting the single-phased mixture into molds;
submerging the molds in the solvent to produce treated molds;
submerging the treated molds in a non-solvent to produce a membrane;
removing the membrane from the molds;
soaking the membrane in the non-solvent;
drying the non-solvent-soaked membrane; and
thermally stabilizing the dried membrane, thereby forming the porosity gradient electrode.

2. The method of claim 1, wherein the scaffold-forming polymer is selected from the group consisting of polyacrylonitrile (PAN), pitch, rayon, phenolic resins, polyimides, PIMS, polyfurfuryl alcohol (PFA), polyetherimide (PEI), poly(2,6-dimethyl-1,4-phenylene oxide) (PPO), and poly(phthalazinone ether sulfone ketone) (PPESK).

3. The method of claim 1, wherein the scaffold-forming polymer is PAN.

4. The method of claim 1, wherein the pore-forming additive is selected from the group consisting of polyvinylpyrrolidone (PVP), polyacrylic acid (PAA), polyacrylamide (PAM), N (2-Hydroxypropyl) methacrylamide (HPMA), poly [N-(2-hydroxy) methacrylamide] (HPMA), and polyethyleneglycol (PEG.

5. The method of claim 1, wherein the pore-forming additive is PVP.

6. The method of claim 1, wherein the solvent is a polar aprotic organic solvent.

7. The method of claim 6, wherein the polar aprotic organic solvent is N,N-dimethylformamide (DMF).

8. The method of claim 1, wherein submerging the molds in the solvent is completed in less than about 1 second(s), 2 s, 5 s, 10 s, 20 s, or 40 s.

9-22. (canceled)

23. The method of claim 1, wherein submerging the treated molds in water comprises submerging the treated molds in boiling water.

24. (canceled)

25. The method of claim 1, wherein submerging the treated molds in water is repeated until the water appears substantially clear.

26. (canceled)

27. The method of claim 1, wherein drying the water-soaked membrane is performed under vacuum.

28. The method of claim 1, wherein drying the water-soaked membrane is performed at about 50° C., about 60° C., about 80° C., about 90° C. or about 100° C.

29-41. (canceled)

42. The method of claim 1, wherein thermally stabilizing the dried membrane is performed in a muffle furnace.

43. The method of claim 1, wherein thermally stabilizing the dried membrane is performed at about 225° C., about 250° C., about 270° C., about 300° C., about 350° C., or about 400° C.

44-55. (canceled)

56. The method of claim 1, wherein following the thermal stabilization of the dried membrane, the membrane is cooled to ambient temperature.

57. (canceled)

58. The method of claim 1, wherein the method further comprises carbonizing the thermally stabilized membrane.

59. (canceled)

60. The method of claim 58, wherein carbonizing the thermally stabilized membrane under an internet atmosphere comprises heating the thermally stabilized to about 1,050° C.

61. (canceled)

62. The method of claim 1, wherein the method further comprises submerging the molds in water prior to prior to submerging the molds in the solvent.

63. A method of fabricating a porosity gradient electrode, the method comprising
a. preparing a single-phase mixture of polyacrylonitrile, polyvinylpyrrolidone, and N,N-dimethylformamide;
b. casting the single-phased mixture of PAN, PVP, and DMF into molds;
c. submerging the molds in DMF to produce treated molds;
d. submerging the treated molds in water to produce a membrane;
e. removing the membrane from the molds;
f. soaking the membrane in water;
g. drying the water-soaked membrane; and
h. thermally stabilizing the dried membrane.

64-78. (canceled)

79. A porous electrode formed by the method of claim 1.

80-94. (canceled)
